(19) United States
(12) Patent Application Publication
(10) Pub. No.: US 2009/0031222 A1
(43) Pub. Date: Jan. 29, 2009

(54) Network design processing device, network design processing method and network design processing program

(75) Inventors: Takeo Nakamura, Kawasaki (JP); Toshiro Okada, Kawasaki (JP); Toshiya Yamazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/232,465

(22) Filed: Sep. 17, 2008

Related U.S. Application Data
(63) Continuation of application No. PCT/JP2006/305358, filed on Mar. 17, 2006.

(51) Int. Cl. G06F 17/50

(52) U.S. Cl. 715/735

(57) ABSTRACT

In a network design processing device 1, a network diagram creation processing section 10 creates/edits a real device network diagram constituted by real devices which physically exist, from input with the use of a computer screen; expresses one or multiple real devices having the same purpose or function as a virtual device to create/edit a virtual device network diagram constituted by virtual devices; and stores configuration data of the real device network diagram, configuration data of the virtual device network diagram, and information about the relationship between the configuration data into a network configuration data storage section 15. A network configuration data output processing section 16 switches among the real device network diagram, the virtual device network diagram and a network diagram in which the network diagrams are overlapped with each other, in response to specification from the outside, and displays the network diagram.

### BACKGROUND OF THE INVENTION

1. Field of the Invention

The present invention relates to a technique for enhancing the efficiency and quality of a series of work such as initial design, verification test, laying and operation of a network infrastructure, which is increasingly becoming complicated and large-scaled recently, for example, for Internet businesses. In particular, the present invention relates to a network design processing device, a network design processing method and a network design processing program for supporting network system design.

As a large-scale network infrastructure, for example, a group of servers and storages of an IDC (Internet data center), and a network configuration for connecting them are conceivable.

2. Description of the Related Art

Recently, with the diversification and expansion of businesses utilizing the Internet, a network infrastructure is becoming indispensable as a social infrastructure. Therefore, stable operation, such as sufficient-security and nonstop operation, is required for a network infrastructure. Hardware and software for satisfying the requirement are also becoming diversified and complicated. Furthermore, in Web services, since it is difficult to estimate the traffic required by customers, it is necessary to perform reinforcement of servers, change in network configuration, and the like while performing operation, and the network infrastructure changes every day. Furthermore, it is necessary to perform infrastructure design/verification in a short time in order to seize a business chance.

Conventionally, design of a network infrastructure has been manually performed with the use of general drawing creation software, word processor software, table editing software and the like, and arrangement of devices, construction and operation have been performed on the basis of designed drawings. However, in order to correctly understand the state-of-the-art and various device configurations and perform optimal design and maintenance, referring to past failure examples, skillful techniques are required. This presents a challenge in efficiency and cost reduction.

As prior-art technical documents in which a technique related to design and operation of a network is described, there are, for example, Patent Document 1 and Patent Document 2. In Patent Document 1, there is described a technique related to design/maintenance of a virtual network (VLAN), which is a technique for displaying a correspondence relationship between a physical network and a virtual network in a manner that it can be easily understood. In Patent Document 2, there is described a technique related to a network operation management system, which is a technique for managing logical objects such as users and relationships among the logical objects and changing the setting for each of devices constituting a network according to a change made in the logical objects and the relationships.

Patent Document 1: Japanese Patent Laid-Open No. 2004-40374

Patent document 2: Japanese Patent Laid-Open No. 9-282253

Conventional network design supporting techniques have a problem as described below. For example, each of a drawing among devices, an abstract drawing in which devices are grouped, a drawing indicating a communication flow (session), and the like is separately and manually created as necessary. Therefore, it is difficult to keep consistency among the drawings, and there may be a case where inconsistency occurs among drawings. It is also difficult to comprehensively utilize information the drawings have.

Furthermore, similar drawings, such as drawings for construction workers, system engineers (SE), customer engineers (CE), operations managers and the like, have been separately created for the processes, respectively. Therefore, it requires a lot of time and effort to create the drawings. Furthermore, there is a problem that, at the time of revision, a mistake may occur due to failure in reflection. Checkup among the drawings has been also manually performed. Furthermore, the drawings are mere documents, and there is a problem that information for mechanically performing checking, such as design rule checking which is commonly performed in CAD design, cannot be obtained from each drawing.

In performing network system design, it is necessary to sufficiently consider how a service session utilizing the network is realized, in addition to the physical configuration of devices. It is necessary not only for a designer but also for SE's, CE's, operations managers and the like who utilize a network diagram to be able to easily grasp what purpose each of physical devices and device groups arranged on the network is used for and what significance it has on the network.

There exists a prior-art technique in which a physical network and a virtual network are designed in association with each other for design of a network, and network addresses assigned to nodes in the virtual network are displayed being overlapped with the configuration of the physical network and the configuration of the virtual network, as shown in Patent Document 1 described above. The technique disclosed in Patent Document 1, however, is a technique for a network having a specific network technique name, such as VLAN (Virtual Local Area Network) and VPN (Virtual Private Network). However, it is not a technique for grouping devices on a network, paying attention to the purpose of each of the devices so that the functional configuration of the entire network can be understandably displayed.

The technique described in the above Patent Document 2 is a technique for managing physical objects on a network and logical object, such as users, in association with each other. Specifically, it is a technique for, in the case where, for example, the section in an organization to which a user who is a logical object belongs changes, making it possible to easily change the address of an information appliance, which is a physical object possessed by the user. However, this is also not a technique for grouping devices on a network, paying attention to the purpose of each of the devices so that the functional configuration of the entire network can be understandably displayed and for facilitating design.

### SUMMARY OF THE INVENTION

In order to solve the above problems, the object of the present invention is to, by grouping physical devices having the same purpose or function on a network as a virtual device and showing virtual interfaces among such virtual devices on the network, make it easy to grasp the entire configuration and function of a network to be designed or a network already designed and make it possible to internally manage information about the relationship between the network of the virtual devices and the network of the real devices so that the relationship information can be effectively utilized.

In order to solve the above problems, the network design processing device of the present invention groups one or multiple real devices having the same purpose or function and expresses the group as a virtual device in a network diagram, and provides a virtual interface port for the virtual device so that virtual interfaces can be connected. A network diagram constituted by the virtual devices is managed as a virtual device network diagram, in comparison with a real device network diagram indicating a network configured by actual physical equipment, and configuration data of the real device network diagram and configuration data of the virtual device network diagram are stored in a database in association with each other. By expressing devices with the same purpose being integrated as a group, display can be simplified.

For the virtual devices in the virtual device network diagram, purpose attributes (hot standby, load distribution and the like) are set, and means for outputting information about the set purpose attributes is provided. Thereby, it is possible to compare the real device network diagram and the virtual device network diagram and check the way of connecting each device according to the purpose attribute. Thus, it becomes possible to easily and accurately check whether connections have been made according to purposes.

Specifically, the present invention is a network design processing device to which a network diagram is inputted with the use of a computer screen and which supports design of a network system, and it is provided with: a network diagram creation processing section having processing means for creating or editing a real device network diagram constituted by real devices which are actual physical equipment, from input with the use of the computer screen, and processing means for creating or editing a virtual device network diagram constituted by virtual devices by expressing one or multiple real devices having the same purpose or function as a virtual device and connecting virtual interface ports defined for virtual devices; a network configuration data storage section which stores configuration data of the real device network diagram created or edited by the network diagram creation processing section, configuration data of the virtual device network diagram, and information about the relationship between the configuration data; and a network configuration data output processing section which switches among output of the real device network diagram, output of the virtual device network diagram and output of a network diagram in which the network diagrams are overlapped with each other, on the basis of the data stored in the network configuration data storage section, in response to specification from the outside, and performs output.

According to the present invention, it is possible to express a physical structure of a network and a virtual structure of the network in which devices are grouped. That is, it is possible to express physical network connections among devices, such as a server, a storage, a router, a firewall and a load distribution device, which constitute a network system, and it is also possible to group the devices according to purposes or functions and express a diagram showing a network of virtual devices having logical meanings. As for the order of design, any of a method of designing a real device network and, after that, designing a virtual device network by grouping the real devices and a method of designing a virtual device network first and then designing a real device network by assigning real devices to virtual devices can be used, and it is possible to improve the degree of designing freedom.

Furthermore, by causing a virtual device, which is a group of grouped devices, to have a virtual interface port and connecting such virtual interface ports, the present invention is capable of expressing virtual network connection relationships which do not dependent on physical devices and thereby making it easy to grasp the logical meaning of a network.

Furthermore, according to the present invention, in the network design processing device described above, the network diagram creation processing section has processing means for setting attribute information which logically creates a meaning of the virtual device on the basis of input with the use of the computer screen, and storing the attribute information into the network configuration data storage section in association with the configuration data of the virtual device; and the network configuration data output processing section has processing means for displaying the attribute information in the virtual device network diagram outputted.

The attribute information to be set for a virtual device is, for example, information about creation of a logical meaning, such as duplication (namely, hot standby system), redundancy distribution and clustering of the device. By storing this attribute information, it becomes possible to output information required to automatically perform design checking, for example, about whether the network configuration is duplicated, whether load distribution can be performed, and the like, at the time of completion of design, and it is possible to obtain data for improving the quality of design.

Furthermore, according to the present invention, in the network design processing device described above, the network diagram creation processing section has processing means for setting a session indicating a logical connection relationship by communication between real devices in the real device network diagram and a session indicating a logical connection relationship by communication between virtual devices in the virtual device network diagram, on the basis of input with the use of the computer screen, and storing, for each session, session attribute information including information about start/end points of the session into the network configuration data storage section. Furthermore, the network configuration data output processing section has processing means for displaying information about the session being overlapped with the real device network diagram, the virtual device network diagram to be outputted, or both of the diagrams.

Thereby, it is possible to express a logical concept of an unsubstantial session. That is, it is possible to show a session indicating a unit or a flow of a logical series of work provided by a service by a network system on a drawing of a real device network diagram and a virtual device network diagram. A session can hold port information about real or virtual devices to be the start and end points of the session as attribute information, and it can also have information such as a protocol of data communication and a logical port number. Therefore, it is possible to make it easier to grasp the roles of devices within the network and the contents of services provided by each device.

Furthermore, according to the present invention, in the network design processing device described above, the network diagram creation processing section has processing means for determining, on the basis of the information about the session set in the virtual device network diagram, the positions of corresponding start and end points in the real device network diagram from the information about the start and end points of the session, developing the session in the virtual device network diagram to a corresponding session in the real device network diagram, and storing information about the developed session into the network configuration data storage section.

Thereby, it is possible to automatically define a session in a real device network diagram from a virtually set session, and therefore, design can be simplified, and mistakes in design can be reduced.

Furthermore, according to the present invention, in the network design processing device described above, the network diagram creation processing section has processing means for, on the basis of input with the use of the computer screen, grouping the multiple virtual devices and indicating the groups as new virtual devices, and storing configuration data of the new virtual devices into the network configuration data storage section.

Thereby, it is possible to further group grouped real devices and manage configuration data with a group nesting structure, and therefore, it is possible to gradually simplify a complicated network structure and present the simplified structure.

According to the present invention, it is possible to express a physical structure of a network and a virtual structure in which real devices with the same purpose or function are grouped, and it is possible to simplify a network diagram and display it in a manner that it is easily understood. Furthermore, by internally managing information about the relationship between a virtual device network, in which attention is paid to the purposes or functions of real devices, and a real device network, it is possible to effectively utilize output of the relationship information for design checking and the like.

Therefore, at a design stage of a large-scale network infrastructure and the like, it is possible to prevent inconsistency and mistakes between logical design and physical design and, thereby, significantly enhance the design quality (accuracy), and it is also possible to realize improvement of efficiency of design work by performing the work on one drawing. Furthermore, a real device network diagram, a virtual device network diagram, and information about the relationship between the network diagrams can be utilized not only when the network system is operated but also when the design of the network system is changed, and thus, they can be effectively utilized for maintenance and improvement of the network system.

### BRIEF DESCRIPTION OF THE DRAWINGS

FIG. 1 is a diagram showing a configuration example of a network design processing device;

FIG. 2 is a diagram illustrating creation of a network diagram;

FIG. 3 is a diagram illustrating the concepts of a real device network and a virtual device network;

FIG. 4 is a diagram showing an example of a network diagram editing screen for a real device network and a virtual device network;

FIG. 5 is a diagram showing an example of a created network diagram;

FIG. 6 is a diagram showing an example of the data structure of network configuration data;

FIG. 7 is a diagram illustrating an example of designing a real device network from a virtual device network;

FIG. 8 is a diagram showing the network diagram in FIG. 7 with the wiring harnesses disassembled;

FIG. 9 is a diagram showing an example of the data structure indicating the network diagram in FIG. 8;

FIG. 10 is a diagram illustrating network diagram editing processing in the case of creating a real device network first;

FIG. 11 is a diagram illustrating network diagram editing processing in the case of creating a virtual device network first;

FIG. 12 is a diagram showing an example of the structure for holding attribute information by an attribute object;

FIG. 13 is a diagram showing examples of a setting file template;

FIG. 14 is a diagram showing an example of a group nesting structure;

FIG. 15 is a diagram showing an example of expression of a session;

FIG. 16 is a diagram showing an example of the internal data structure of a network diagram in which a session is expressed;

FIG. 17 is a diagram illustrating session information editing processing;

FIG. 18 is a flowchart of session development processing;

FIG. 19 is a diagram showing an example in which a session has been developed, from a virtual device network to a real device network;

FIG. 20 is a diagram showing an example of an internal data structure when a session is developed from a virtual device network to a real device network;

FIG. 21 is a diagram illustrating an example of development of a session in the case where HUBs are trunk-connected;

FIG. 22 is a diagram showing an example of the internal data structure of a network diagram in the case where HUBs are trunk-connected;

FIG. 23 is a diagram showing the concept of expression of a diagram with layers;

FIG. 24 is a diagram showing an example of expression of a diagram with layers;

FIG. 25 is a diagram showing an example of expression of a diagram with layers;

FIG. 26 is a diagram showing an example of expression of a diagram with layers;

FIG. 27 is a diagram showing an example of expression of a diagram with layers;

FIG. 28 is a diagram showing an example of expression of a diagram with layers; and

FIG. 29 is a diagram showing an example of a layer management structure.

### DESCRIPTION OF SYMBOLS

1 network design processing device
2 input/output device
10 network diagram creation processing section
11 real device network editing section
12 virtual device network editing section
13 session information editing section
14 association processing section
15 network configuration data storage section
16 network configuration data output processing section
20 display screen
21 network diagram editing window
22 equipment stencil window
23 virtual device stencil window
24 property setting window
3 real device network
4 virtual device network

### DETAILED DESCRIPTION OF THE PREFERRED EMBODIMENT

An embodiment of the present invention will be described with the use of drawings.

### <Configuration of Network Design Processing Device>

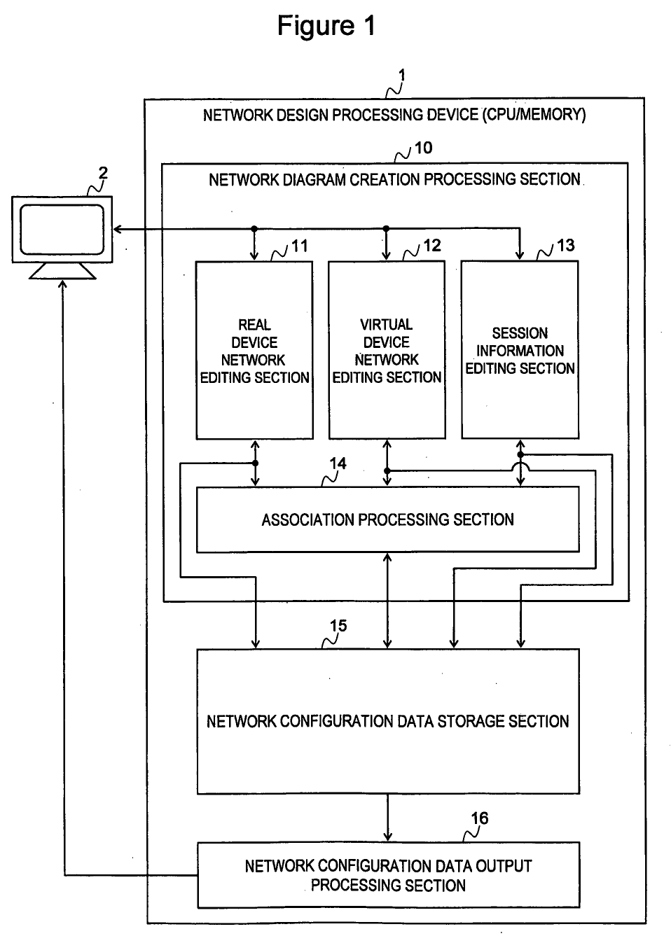

FIG. 1 is a diagram showing a configuration example of a network design processing device according to an embodiment of the present invention. A network design processing device 1 is a computer system configured by hardware constituted by a CPU, a memory and the like, and a software program. The network design processing device 1 is provided with a network diagram creation processing section 10 realized by the hardware and the software program, a network configuration data storage section 15 and a network configuration data output processing section 16. The network diagram creation processing section 10 is provided with a real device network editing section 11, a virtual device network editing section 12, a session information editing section 13 and an association processing section 14.

An input/output device 2 is configured by a display device, a mouse, a keyboard and the like, and it is connected to the network design processing device 1.

The network diagram creation processing section 10 has processing functions of graphic processing software, such as CAD (Computer Aided Design), and it performs processing for creating a network diagram by input/output from the input/output device 2. The real device network editing section 11 performs processing for creating and editing a network diagram constituted by actual physical devices (referred to as real devices), and it has a network diagram creation function similar to that of the prior-art techniques. The virtual device network editing section 12 performs processing for creating and editing a network diagram in which the components are virtual devices grouped according to purposes or functions (referred to virtual devices).

The session information editing section 13 performs processing for editing session information indicating logical connection by communication among real devices or among virtual devices. The association processing section 14 stores network configuration data defined by the real device network editing section 11, the virtual device network editing section 12 and the session information editing section 13 into the network configuration data storage section 15 in association with one another so that the relationships among the configuration data can be understood. Here, storing the network configuration data in association with one another sections, for example, storing configuration data of network elements related with one another in a manner that the data are linked with one another.

The network configuration data storage section 15 stores the data about network configuration, such as data of real devices, virtual devices, session information and attribute information about them, which has been created by the network diagram creation processing section 10.

The network configuration data output processing section 16 performs processing for outputting various information indicating the network configuration, such as a real device network diagram, a virtual device network diagram, a network diagram in which the network diagrams are overlapped with each other, and the network diagrams in which session information is further shown, on the basis of the data stored in the network configuration data storage section 15.

### <Creation of Network Diagram>

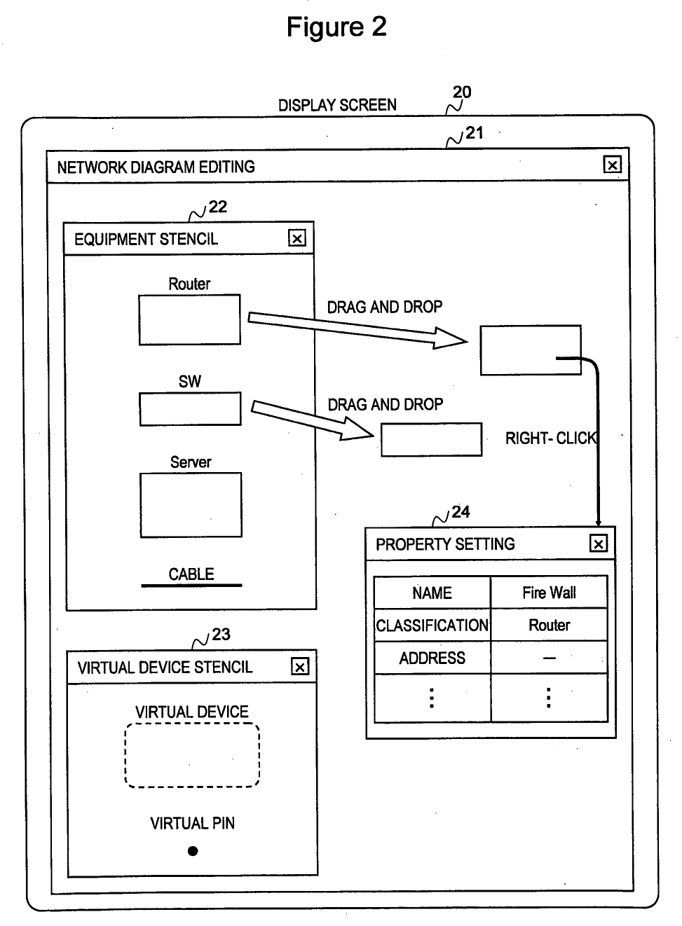

FIG. 2 is a diagram illustrating creation of a network diagram. When creating a network diagram, a network designer creates the network diagram on a network diagram editing window 21 on a display screen 20 as shown in FIG. 2, by utilizing a GUI (Graphical User Interface) of the network diagram creation processing section 10 with the use of the input/output device 2. Description will be made on an example of a case where a mouse having left and right buttons is used as a pointing device for creating a network diagram. Similar processing can be also performed with the use of a different pointing device.

In an equipment stencil window 22, equipment components to be used for a real device network are arranged on the basis of data in a parts library prepared in advance. Similarly, components to be used for creating a virtual device network are arranged in a virtual device stencil window 23. By selecting an equipment component to be arranged on a network diagram, from the equipment stencil window 22 or the virtual device stencil window 23 with the left button of the mouse, and immediately drag-and-dropping it, the designer arranges the selected equipment component on the network diagram. Such a network diagram creation method to which CAD is applied is a method which has been conventionally used.

In response to an operation against the equipment stencil, the real device network editing section 11 operates. In response to an operation against the virtual device stencil, the virtual device network editing section 12 operates. Session information can also be inputted with the use of a session setting stencil, a menu or the like. In response to input of session information, the session information editing section 13 operates.

It is possible to set various attribute information for real devices, virtual devices, sessions and the like arranged on a network diagram as necessary. In the example in FIG. 2, by clicking the graphic of a real device arranged onto the network diagram by being drag-and-dropped with the right button of the mouse to open a property setting window 24, and attributes of the real device (a router), such as the name and the address, are set on the property setting window 24.

As for attribute information about each of equipment and the like to be arranged on a network diagram, it can be defined in advance for each component of the equipment stencil or the virtual device stencil. The attribute information can be held in an attribute file (not shown) managed by the network diagram creation processing section 10 as component attribute information. In the property setting window 24, as for attribute items defined in the attribute file in advance, attribute information read from the attribute file is embedded as a default value. Therefore, the designer has to input only attribute information specific to each of equipment and the like, from the property setting window 24. For example, he has to input only minimum attribute information, for example, the host name of and address information about a server.

### <Real Device Network and Virtual Device Network>

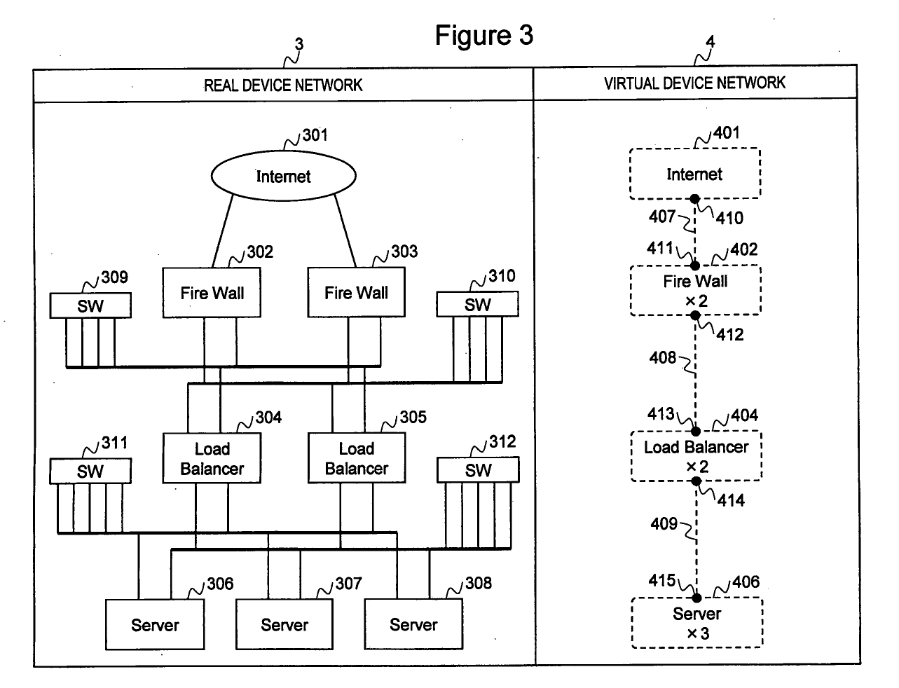

FIG. 3 is a diagram illustrating the concepts of a real device network and a virtual device network. A real device network 3 is a network the components of which are really existing physical devices. A network diagram which has been conventionally created with the use of a CAD system or the like corresponds to this real device network 3. Here, the Internet 301 is also regarded as a real device. In addition, there are real devices, such as fire walls 302 and 303, load distribution devices 304 and 305, server devices 306 to 308, switch devices 309 to 312 such as hubs, and these are connected via lines to constitute a network.

In network design, a network diagram of the real device network 3 as shown in FIG. 3 is indispensable to arrange actual network equipment and connect the equipment at a job site. However, in such a network diagram in which real devices are arranged, the number of devices increases as the scale becomes larger, and the relationships among the devices are complicated and difficult to grasp. Especially, it is very difficult to grasp how a service session which utilizes the network is realized even if looking at the network diagram of the real device network 3.

In the present invention, concepts of grouping of real devices, virtual interface ports and virtual connection are introduced to the real device network 3 so that a virtual device network 4 as shown in FIG. 3 can be defined on a network diagram. In the case of designing a redundant configuration of a network system and in the case of designing which route a session for providing a service passes through, a logical network diagram like the virtual device network 4 is easier to understand.

Grouping means integrating multiple real devices and treating them as one virtually configured device (referred to as a virtual device). It is also possible to define one real device as one virtual device as an exception. In the example in FIG. 3, since the two fire walls 302 and 303 in the real device network 3 are firewalls configured in duplicate, they are shown as one virtual device 402 in the virtual device network 4.

Similarly, since the load distribution devices 304 and 305 for allocating processing requests from the outside to the server devices 306 to 308 are also configured in duplicate and they are intended for the same purpose, they are grouped together and shown as a virtual device 404 in the virtual device network 4. The server devices 306 to 308 are devices which execute the same service in response to a processing request from the outside, and they are also shown as a virtual device 406 in the virtual device network 4. In order to make the entire network configuration clear, the Internet 301 in the real device network 3 is also shown as one virtual device 401 in the virtual device network 4.

For these virtual devices 401, 402, 404 and 406, there are provided virtual interface ports 410 to 415 which are to be connection ports for input/output among the virtual devices. By these virtual interface ports 410 to 415 being connected via lines, virtual connection relationships are expressed as shown as virtual connections 407 to 409 in the virtual device network 4. The lines indicating the virtual connections 407 to 409 are referred to as virtual nets. For example, the switch devices 309 and 310 are involved in the virtual connection 408.

Existing common drawing editing tools and circuit drawing editing tools also perform graphic grouping processing. However, the grouping is performed merely for integration for movement or copying. This embodiment is characterized in that it is possible to express communication with the outside by providing a virtual interface port for grouped elements (namely, a virtual device), and that it is possible to create a meaning of the group by setting attributes for the group.

The network diagram creation processing section 10 in the network design processing device 1 has a function of creating and editing the real device network 3 and the virtual device network 4 as shown in FIG. 3 on the same display screen, associating them with each other.

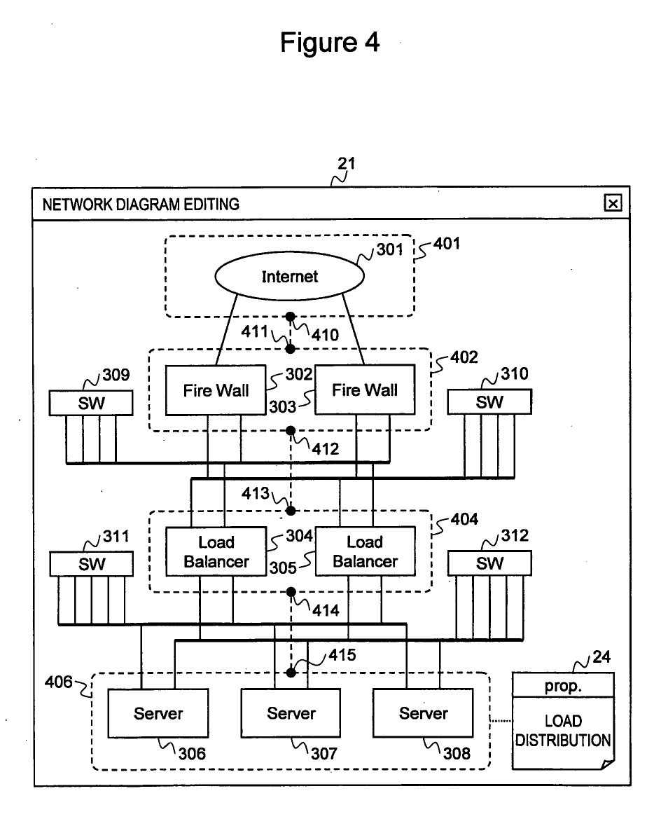

FIG. 4 shows an example of a network diagram editing screen for a real device network and a virtual device network. The reference numerals shown in FIG. 4 correspond to the reference numerals shown in FIG. 3. Reference numeral 24 denotes a property setting window for the virtual device 406. In the present invention, a method is basically used in which a virtual device network is created by creating a real device network first on a screen and grouping real devices of the same purpose or function on the real device network. However, it is also possible to use a method in which a real network is completed by creating a virtual device network first and assigning real devices on the virtual device network. Creation of a real device network and creation of a virtual device network can be performed in parallel.

It is possible not only to display both a real device network and a virtual device network in the network diagram editing window 21 being overlapped with each other but also to select a layer from a menu not shown to selectively display only the real device network or only the virtual device network. Furthermore, it is also possible to easily perform various kinds of selective display, for example, display of real devices corresponding to a particular part of virtual devices selected from a part of a network drawing displayed being enlarged, due to the data structure of data stored in the network configuration data storage section 15 to be described next.

### <Data Structure of Network Configuration Data>

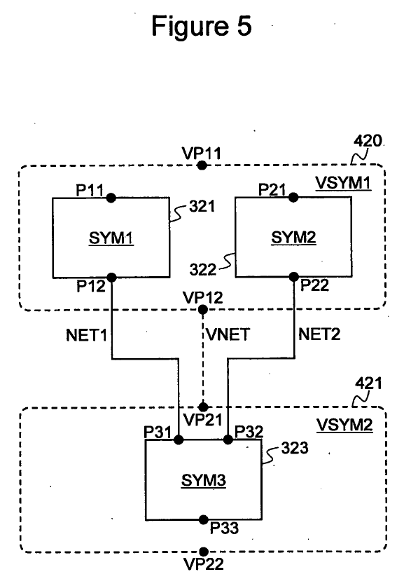

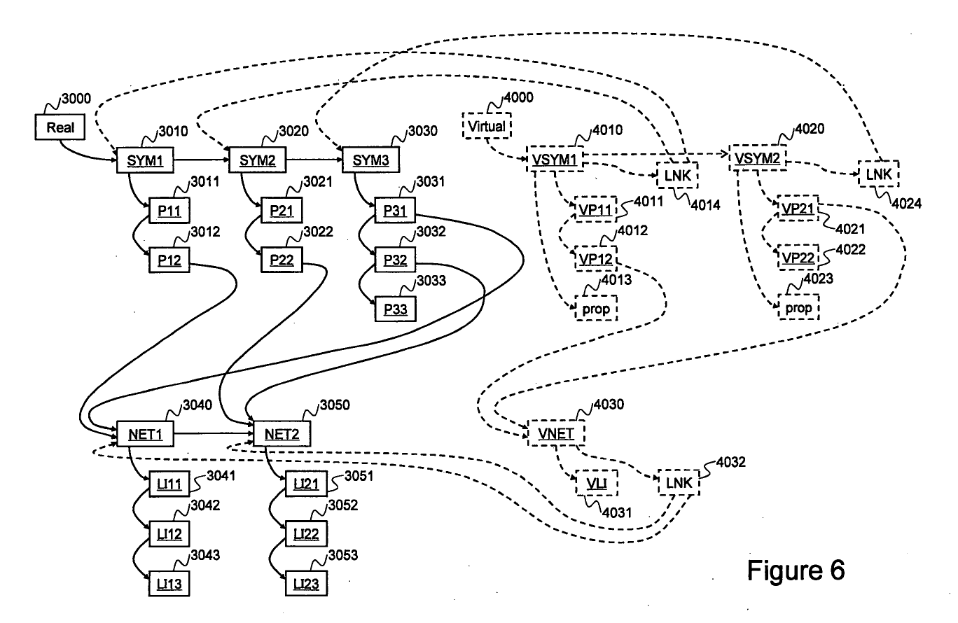

The data structure of network configuration data stored in the network configuration data storage section 15 will be described with the use of FIGS. 5 and 6.

FIG. 5 shows an example of a network diagram created by the network diagram creation processing section 10. In a network diagram, devices are denoted by symbols. The symbols are graphic shapes indicating devices on the diagram. In the network diagram in FIG. 5, real devices 321 and 322 denoted by symbols SYM1 and SYM2 are grouped and defined as a virtual device 420. In this example, the symbol denoting the virtual device 420 is shown as a virtual symbol VSYM1. A real device 323 denoted by a symbol SYM 3 is defined as one virtual device 421, and it is shown as a virtual symbol VSYM2.

The real device 321 is provided with input/output pins P11 and P12; the real device 322 is provided with pins P21 and P22; and the real device 323 is provided with pins P31 to P33. The pins P12 and P31 are connected via a net NET1 which is a group of lines, and the pins P22 and P32 are connected via a net NET2.

The virtual device 420 is provided with virtual interface ports VP11 and VP12 to indicate communication relationships with other network elements, and the virtual device 421 is provided with virtual interface ports VP21 and VP22. The virtual interface port VP12 and the virtual interface port VP21 are connected via a virtual net VNET.

The data showing the real device network and the virtual device network as shown in FIG. 5 has a data structure as shown in FIG. 6, and it is stored in the network configuration data storage section 15. In this embodiment, network components in a real device network and a virtual device network are called objects, and the data of these objects are managed by being linked by pointers.

In FIG. 6, reference numeral 3000 denotes a real device layer pointer which points at a top object of a real device network, and reference numeral 4000 denotes a virtual device layer pointer which points at a top object of a virtual device network. Reference numerals 3010, 3020 and 3030 denote symbol objects corresponding to the virtual devices 321, 322 and 323 shown in FIG. 5, respectively. Pin objects 3011 to 3033 are linked to the symbol objects 3010, 3020 and 3030. To the pin objects 3012, 3022, 3031 and 3032 connected to lines, net objects 3040 and 3050 are linked. To these net objects, line objects 3041 to 3053 constituting nets, respectively, are linked.

On the other hand, to the virtual device layer pointer 4000, virtual symbol objects 4010 and 4020 corresponding to the virtual devices 420 and 421 shown in FIG. 5 are linked like a chain. To these objects, virtual pin objects 4011 to 4022 indicating virtual interface ports, respectively, are linked. To the virtual symbol objects 4010 and 4020, attribute information 4013 and 4023, such as the purpose, classification and meaning of the virtual devices, indicating, for example, what purpose the virtual device is used for, is linked, respectively. Furthermore, link information 4014 and 4024 about links to real devices indicating which real devices the virtual device is configured by, is also linked, respectively.

Furthermore, similarly to the net objects of the real device, a virtual net object 4030 corresponding to connection of a virtual interface port is linked from the virtual pin objects 4012 and 4021, and a virtual line object 4031 and link information 4032 about links to real devices are linked from the virtual net object 4030. It is also possible to make the symbol objects of the real devices hold attribute information though it is not shown in FIG. 6.

In the data structure as described above, an object holds graphic form information. However, as apparent from FIG. 6, it is also possible to express a virtual symbol of a virtual device with a structure similar to that for an entity device symbol, and it is possible to hold expression of network diagrams with different levels of a real device network and a virtual device network with one data structure. The data of the real device network and virtual device network as shown in FIG. 5 is managed by such a data structure.

As described above, in this embodiment, a logical network diagram referred to as a virtual device network is expressed by:

1) grouping real devices expressed on a physical network diagram referred to as a real device network to generate virtual devices;

2) giving virtual interface ports to the groups; and

3) connecting the virtual interface ports with one another.

Furthermore, for each group,

4) it is possible to set the meaning and attributes of the group. By outputting the set meaning and attributes of the group for each virtual device as list information, they can be utilized for checking of design rules performed after design of the network, and the like. For example, they can be utilized to check whether a necessary device is duplicately configured so that it does not go down even in the case of occurrence of a fault. It is also possible to further group the groups.

<Design of Real Device Network from Virtual Device Network>

In the example described before, a virtual device network is defined by grouping real devices in a real device network and defining virtual devices. However, it is also possible to create a virtual device network first and then design a real device network by assigning and arranging actual physical devices to virtual devices on the virtual device network. An example thereof will be described next.

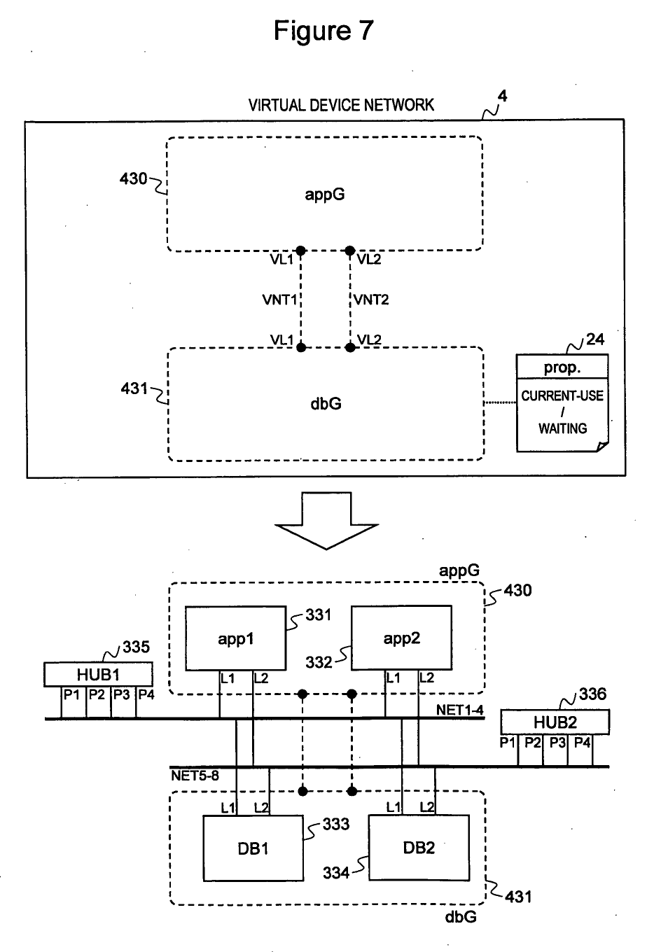

First, a virtual device network 4 as shown on the upper side of FIG. 7 is designed on the basis of functions required for a network. A virtual device 430 is a group of application server devices, which is denoted by a virtual symbol appG, and a virtual device 431 is a group of database server devices, which is denoted by a virtual symbol dbG. The virtual device 430 and the virtual device 431 are connected through virtual nets VNT1 and VNT2 via virtual interface ports VL1 and VL2. Attribute information “current-use/waiting” is defined for the virtual device 431 in the property setting window 24. That is, it is defined that at least two server devices, a current-use-system server device to be used for actual operation and a waiting-system server device to be switched with the current-use-system server device in the case of occurrence of a fault, are prepared as database server devices.

For example, the virtual interface port on the side of the virtual device 430 of the virtual net VNT1 (similar for VNT2) and the virtual interface port on the side of the virtual device 431 are denoted by the same VL1. However, they are different ports. When it is necessary to distinguish between them for convenience of description, the virtual interface port on the side of the virtual device 430 is denoted by “appG.VL1”, and the virtual interface port on the side of the virtual device 431 is denoted by “dbG.VL1”.

Here, in order to design an actual physical real device network, real devices are assigned to the virtual devices 430 and 431 by the real device network editing section 11. Here, as shown in the lower side diagram in FIG. 7, a design is made in which real devices 331 and 332 of two application server devices the device symbols of which are denoted by app1 and app2 are arranged for the virtual device 430, and real devices 333 and 334 of two database server devices the virtual symbols of which are denoted by DB1 and DB2 are arranged for the virtual device 431. As the virtual nets VNT1 and VNT2, nets having a real device 335 of a hub device (HUB1) and a real device 336 of a hub device (HUB2), respectively, are used.

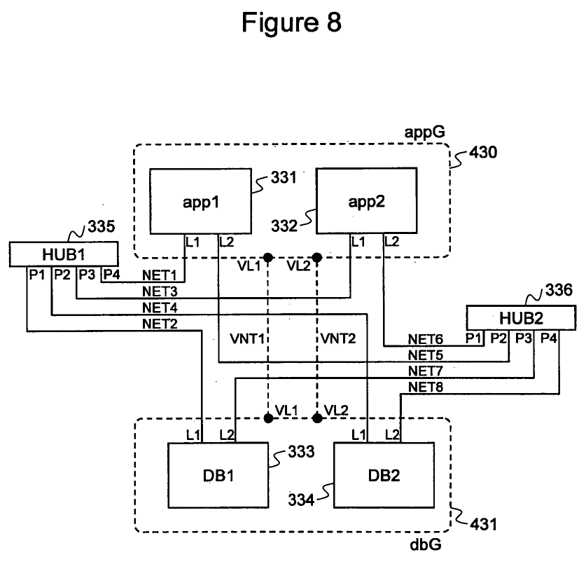

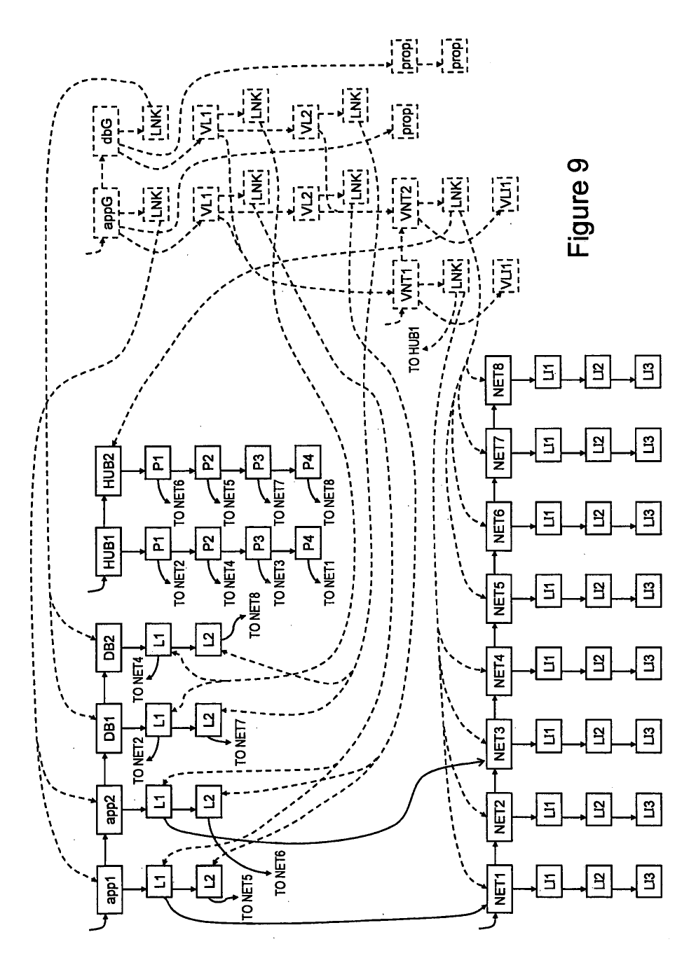

As interface ports of the real devices, ports P1 to P4 of the hub devices (HUB1 and HUB2) and pins L1 and L2 of each of the real devices 331 to 334 are defined. Though connection relationships are shown being simplified by using wiring harnesses in the network diagram in FIG. 7, actual connections are as shown in FIG. 8. Therefore, in the case of storing the network diagram shown on the lower side of FIG. 7 into the storage device of the network configuration data storage section 15, it is stored in the data structure as shown in FIG. 9.

In FIG. 9, objects and links related to a real device network are indicated by solid lines, and objects and links related to a virtual device network are indicated by dotted lines. However, the relationships among objects are similar to those described with regard to the data structure in FIG. 6. Attribute information is denoted by prop, and link information about links to real devices is denoted by LNK.

Virtual pin objects (VL1 and VL2) are virtual interface port objects set for groups. In the example in FIG. 9, the virtual pin objects hold link information (broken-line arrows) about links to entity pin objects. A link between a virtual interface port and a real device interface port is utilized, for example, in the case of mapping the concept of a session to be described later, from a group to a real device, in the case of checking design rules of a real device on the basis of a correspondence relationship between a virtual device and the real device, and the like.

A link between a virtual pin and a pin of a real device is not limited to one-to-one correspondence. Both of one-to-n correspondence that one virtual pin corresponds to multiple real device pins and n-to-one correspondence that multiple virtual pins correspond to one real device pin are also possible. For example, in the example in FIG. 9, appG→VL1→LNK links to two positions of app1→L1 and app2→L1. Furthermore, though the link direction is assumed to be one-way in this embodiment, a bidirectional link structure is also possible. When the link direction is bidirectional, processing for referring to a real device from a virtual device and processing for referring to a virtual device from a real device can be easily realized.

As for the entity of an device which is a part of wiring, such as a network switch which is a part of a network connection, by providing link information about the link from a virtual net object to the device symbol object, the correspondence relationship between a virtual device network and a real device network can be expressed. In the example in FIG. 9, by the links from virtual net objects (VNT1 and VNT2) to device symbol objects (HUB1 and HUB2) of hub devices, the correspondence relationships between them are shown.

### <Editing of Network Diagram>

As described before, it does not matter which of design of a real device network and design of a virtual device network is performed first. Now, description will be made below on an example of a network structure editing operation and network structure editing processing, with regard to two cases of designing a real device network first and designing a virtual device network diagram first.

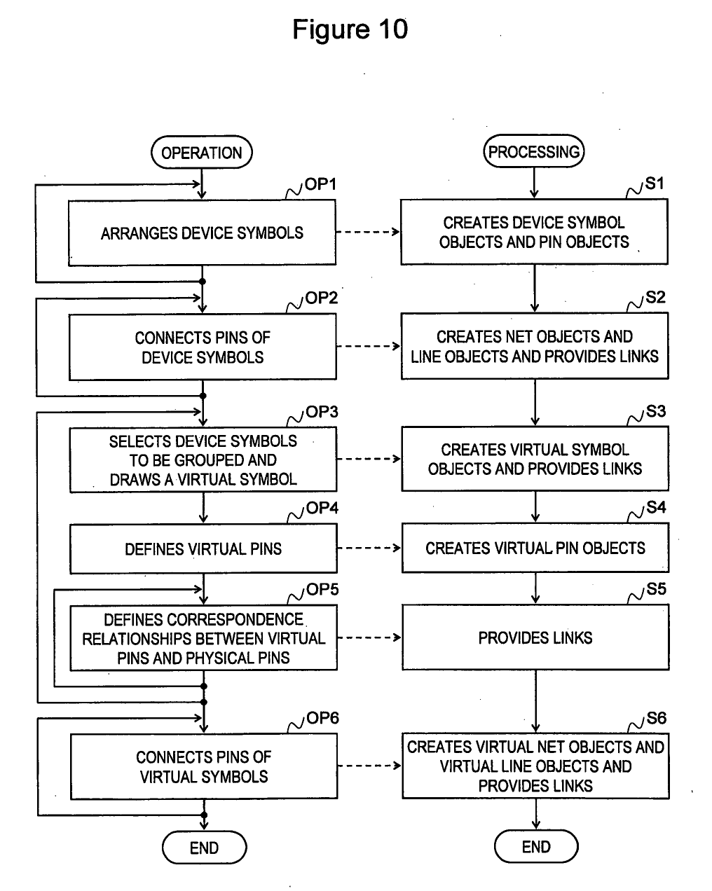

FIG. 10 is a diagram illustrating network diagram editing processing in the case of creating a real device network first. Here, an example of editing a network diagram in the case of designing a real device network first and, after that, designing a virtual device network is shown.

When, in the network diagram editing window 21 as shown in FIG. 2, an device symbol is selected from the equipment stencil window and arranged on a drawing (OP1), the real device network editing section 11 creates an device symbol object and a pin object to be stored into the network configuration data storage section 15 (S1). Symbols of real devices are prepared in advance as library information, and information about graphic shapes and interface ports (pins) corresponding to real devices are held as a database. The above operation OP1 and the processing step S1 are repeated the number of times corresponding to the number of devices required.

Next, when the pins of device symbols arranged on the network diagram are connected to each other via a line by an operation of connecting the pins of the device symbols, and a connection relationship (net) between them is made clear (OP2), the real device network editing section 11 creates a net object and a line object indicating a graphic shape. The association processing section 14 provides a link between the pin object and the net object (S2). The operation OP2 and the processing step S2 are repeated the number of times corresponding to the number of nets required.

Subsequently, the processing proceeds to editing of a virtual device network. When device symbols to be grouped are selected on the network diagram and the shape of a virtual symbol is drawn on the network diagram (OP3), the virtual device network editing section 12 creates a virtual symbol object. The association processing section 14 provides a link between the virtual symbol object and the device symbol objects (S3).

Next, when a virtual pin is defined for the virtual symbol on the network diagram (OP4), the virtual device network editing section 12 creates a virtual pin object (S4). The definition of the virtual pin may be explicitly specified. It is also possible that the definition is automatically performed by drawing out a virtual net from the virtual symbol.

Next, in response to an operation of defining a correspondence relationship between the virtual pin and a real device pin (OP5), the association processing section 14 provides a link between the virtual pin object and the pin object (S5). The operation OP5 and the processing step S5 are repeated the number of times corresponding to the number of the virtual pins of the virtual symbol. It is also possible to automatically associate virtual pins and real device pins by a heuristic method on the basis of classifications of device symbols, classifications of pins, connection relationships among the device symbols, and the like. In this case, it is possible to display the result of the automatic association on the screen and, only for positions where association has not been performed, manually associate virtual pins and real device pins. The above operations OP3 to OP5 and processing steps S3 to S5 are repeated the number of times corresponding to the number of virtual symbols required.

When the virtual pins of virtual symbols are connected to each other via a line by an operation of connecting the pins of the virtual symbols, and a virtual connection relationship (virtual net) between them is made clear (OP6), the virtual device network editing section 12 creates a virtual net object and a virtual line object indicating a graphic shape. The association processing section 14 provides links between the virtual pin objects and virtual net objects. Furthermore, since a correspondence relationship between the virtual net and a real device net is apparent from correspondence relationships between the virtual pins and real device pins, a link is provided between the virtual net object and the real device net object (S6). The operation OP6 and the processing step S6 are repeated the number of times corresponding to the number of virtual nets required.

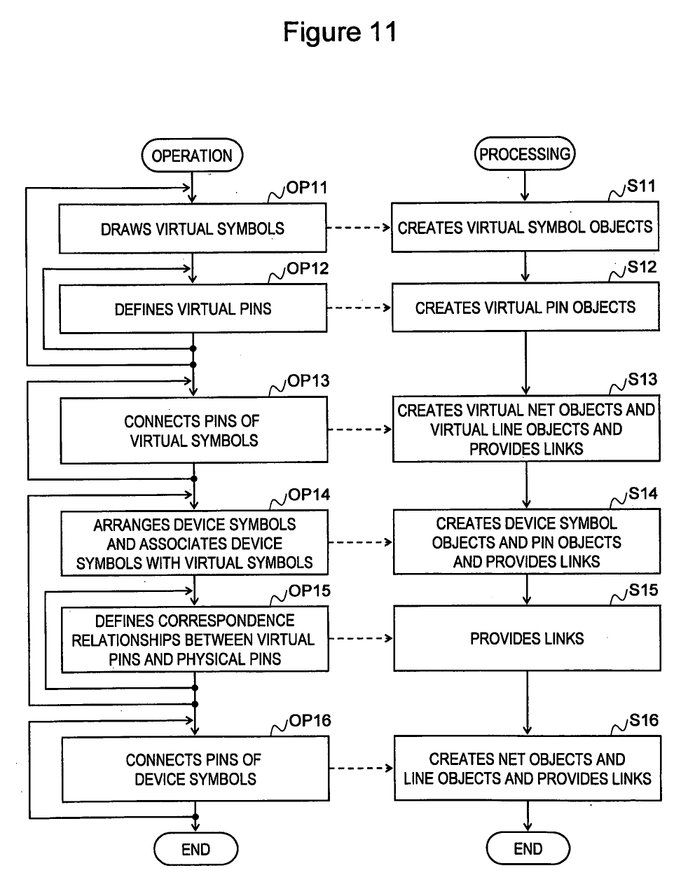

FIG. 11 is a diagram illustrating network diagram editing processing in the case of creating a virtual device network first. Here, an example of editing a network diagram in the case of designing a real device network first and, after that, designing a virtual device network is shown.

When an operation of drawing the shape of a virtual symbol is performed on the network diagram (OP11), the virtual device network editing section 12 creates a virtual symbol object (S11). When a virtual pin is defined for the virtual symbol on the network diagram (OP12), the virtual device network editing section 12 creates a virtual pin object (S12). The operation OP12 and the processing step S12 are repeated the number of times corresponding to the number of virtual pins required. The definition of the virtual pin may be explicitly specified. It is also possible that the definition is automatically performed by drawing out a virtual net from the virtual symbol.

The above operations OP11 and OP12 and processing steps S11 and S12 are repeated the number of times corresponding to the number of virtual symbols required.

When the virtual pins of virtual symbols are connected to each other via a line by an operation of connecting the pins of the virtual symbols, and the virtual connection relationship (virtual net) between them is made clear (OP13), the virtual device network editing section 12 creates a virtual net object and a virtual line object. The association processing section 14 provides links between the virtual pin objects and virtual net objects (S13). The operation OP13 and the processing step S13 are repeated the number of times corresponding to the number of virtual nets required.

When an device symbol is arranged on the network diagram, and the device symbol and a virtual symbol is associated (OP14), the real device network editing section 11 creates an device symbol object and a pin object, and the association processing section 14 provides a link between the virtual symbol object and the device symbol object (S14). Device symbols are prepared in advance as library information, and graphic shapes and interface ports (pins) corresponding to real devices are provided in a library database. Furthermore, by arranging an device symbol in a virtual symbol, an operation for explicitly associating them with each other can be omitted. Since scaling of an device symbol is possible on the network diagram, it is possible to reduce an device symbol to be included in a virtual symbol. Though it is also possible to arrange a virtual symbol and an device symbol away from each other on the network diagram, the operation for explicitly associating them with each other is required in this case.

When a correspondence relationship between a virtual pin and a real device pin is defined by an operation subsequently performed (OP15), the association processing section 14 provides a link between a virtual pin object and a pin object (S15). The operation OP15 and the processing step S15 are repeated the number of times corresponding to the number of the virtual pins of the virtual symbol. It is also possible to automatically associate virtual pins and the real device pins by a heuristic method on the basis of classifications of device symbols, classifications of pins, connection relationships among the device symbols, and the like. In this case, it is possible to display the result of the automatic association on the screen and, only for positions where association has not been performed, manually associate virtual pins and real device pins.

The above operations OP14 and OP15 and processing steps S14 and S15 are repeated the number of times corresponding to the number of device symbols required.

When the pins of the device symbols are connected to each other via a line by an operation of connecting the pins of the device symbols, and the physical connection relationship (net) is made clear (OP16), the real device network editing section 11 creates a net object and a line objects indicating a graphic shape. The association processing section 14 provides a link between the pin object and the net object. Furthermore, since a correspondence relationship between a virtual net and the real device net is apparent from a correspondence relationship between a virtual pin and the real device pin, a link is provided between the virtual net object and the net object (S16). The operation OP16 and the processing step S16 are repeated the number of times corresponding to the number of nets required.

### <Creating Meaning of Group>

For example, in the case of grouping multiple device in an actual network, various meanings of the grouping are conceivable, such as duplication (hot standby function), redundancy distribution and clustering. In the present invention, such information about a purpose/function is held as attribute information, for creation of a meaning of a virtual device obtained by grouping real devices. It becomes possible to automatically generate device configuration information on the basis of the attribute information set for the group.

In the data structure shown in FIG. 9, attribute information about virtual symbol objects are held as attribute information objects (prop). Though only the virtual symbol objects hold the attribute information objects in the example in FIG. 9, other objects, such as virtual net objects, device symbol objects and net objects, can also hold attribute information objects.

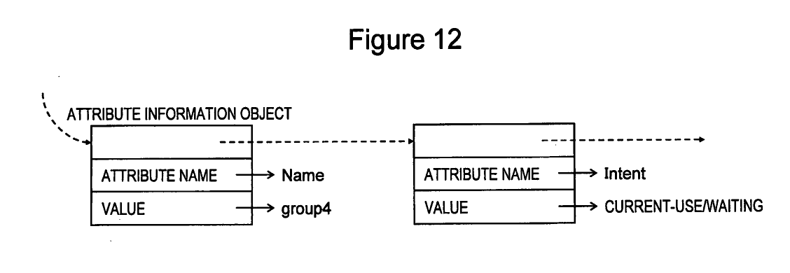

FIG. 12 is a diagram showing an example of a structure for holding attribute information by an attribute object. Attribute information objects have a similar structure irrespective of their parent objects, such as a virtual symbol object and a virtual net object. A meaning created for a virtually integrated group can be held as property information by this attribute information holding structure.

Next, an example of generating configuration information from the attribute information will be described on the basis of an example of setting for current-use/waiting systems (using a virtual address) in Red Hat (registered trademark) Linux. Here, it is assumed that each of related objects has a property as shown below.

DBn.Lx.name: an interface name property given to Lx of DBn;

DBn.Lx.net.*: a net-related property given to Lx of DBn;

dbG.VLy.number: a number given to a virtual interface y of a DB group (dbG); and

dbG.VLy.net.*: a virtual-net-related property associated with the virtual interface y of the DB group (dbG).

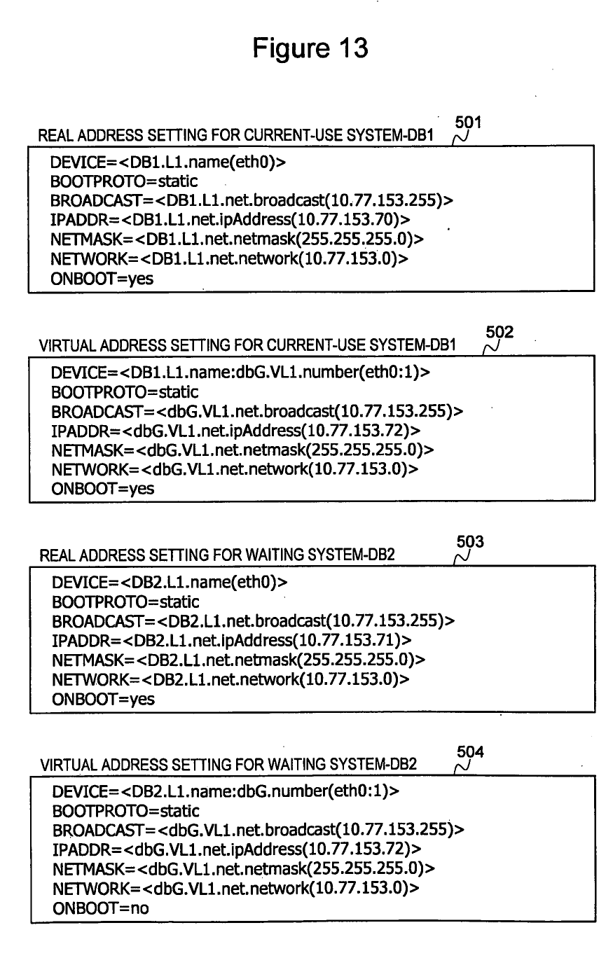

FIG. 13 shows examples of a setting file template. In FIG. 13, reference numeral 501 denotes a real address setting file template for the current-use system (DB1); reference numeral 502 denotes a virtual address setting file template for the current-use system (DB1); reference numeral 503 denotes a real address setting file template for the waiting system (DB2); and reference numeral 504 denotes a virtual address setting file template for the waiting system (DB2).

By preparing a setting file template as shown in FIG. 13 and replacing the descriptions in braces with property values in attribute information objects, a configuration file can be generated. The descriptions in parentheses in FIG. 13 show concrete values.

The setting file examples in FIG. 13 show information on the L1 (VL1) side. In the examples, since the “virtual address used” attribute is included in the redundancy property, it is known that the form is such that the real interface of L1 associated with VL1 through LNK has its own settings, and virtual settings from VL1 are added thereto. Therefore, the settings are developed in consideration of the situation. The same way of thinking applies to the L2 side omitted. It is the only difference that L1 (VL1) is replaced with L2 (VL2).

The characteristics of this setting example are as follows:

1) The real address setting is different between the current-use system and the waiting system (10.77.153.70 and 10.77.153.71), and both of them are enabled at boot time (ONBOOT=yes).

2) The virtual address setting is shared by the current-use system and the waiting system (10.77.153.72). However, the current-use system is enabled at boot time (ONBOOT=yes), while the waiting system is disabled at boot time (ONBOOT=no).

### <Group Nesting Structure>

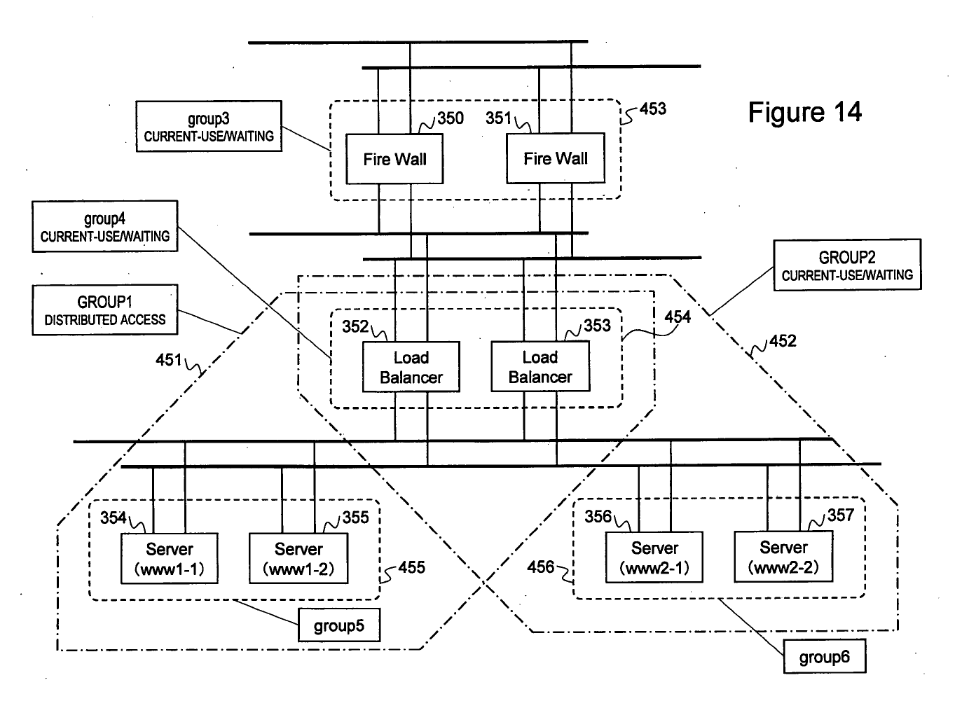

FIG. 14 is a diagram showing an example of a group nesting structure. In FIG. 14, reference numerals 350 to 357 denote real devices. Reference numerals 451 to 456 denote virtual devices, and they are given names GROUP1 and GROUP2 and group3 to group6, respectively.

In this embodiment, it is also possible to further perform grouping of groups integrated as virtual devices. In the example in FIG. 14, GROUP1 has a nest structure of including group4 and group5 in the group. Furthermore, GROUP2 has a nest structure of including group4 and group6 in the group.

In FIG. 14, group5 constituted by real devices 354 and 355 of Servers www1-1 and www1-2, and group6 constituted by real devices 356 and 357 of Servers www2-1 and www2-2 are given only group names and not given description of duplicate configuration in attribute information. In this case, the real devices 354 and 355 and the real devices 356 and 357 which are servers constituting the groups do not know that they are grouped. They are only responsible for the role of informing Load Balancers included in a “group higher than the group”, of group5 and group6 which are the server groups under themselves.

In FIG. 14, group3 constituted by two Firewalls and group4 constituted by two Load Balancers are the bottom layer groups of the current-use/waiting groups. In these groups which are given the current-use/waiting attribute, switching between current use and waiting is performed by an operation of confirming whether live or dead, among servers constituting the groups. It is also possible to manually perform switching (cold standby function, and the like). This can be realized, for example, by describing a method for switching of “current-use/waiting” in sub-attributes indicating the detailed contents of attribute information.

In FIG. 14, the attribute of GROUP2 constituted by group4 and group6 is current-use/waiting among higher groups among the groups. Under the logic that “Load Balancer has to be responsible for redundant access within its group as its nature”, each Load Balancer element describes a redundancy method (current-use/waiting) for “the groups higher among the groups” in its setting file so that servers constituting the groups can execute a current-use/waiting operation. In this case, for example, it is necessary to make a setting about “which timing the current-use system is judged to be ‘dead’” in the sub-attribute indicating the detailed contents of the attribute information.

In FIG. 14, the attribute of GROUP1 constituted by group4 and group5 is distributed access among the higher groups among the groups. Under the same logic as the case of GROUP2, it is necessary to make a setting for performing redundant access, for Load Balancers. As the sub-attribute, a distribution method, such as minimum load, round-robin and a live-or-dead judgment method, is described.

The internal structure for nesting the groups is basically similar to the structure in FIG. 9, and it can be expressed by providing a link from a virtual symbol object of a higher concept to a virtual symbol object of a lower concept.

Contrary to the example in FIG. 14, there may be a case where the inside of one piece of equipment is virtually divided into multiple functions/devices like the (port) VLAN function of hub and the zoning of a server. This can be also treated similarly to the case of the group nesting structure described above. For example, group5 in FIG. 14 can be assumed to be one server, and Servers www1-1 and www1-2 included therein can be assumed to be zones within the server obtained by zoning, respectively.

The data holding structure in this case can be also realized by extending the description made so far. When thinking of the case of extending the data structure in FIG. 9 as an example, the data holding structure in the case of separating functions can be realized as described blow:

1) adds links (LNKs) to objects indicating real devices (for example, app1, DB1, L1 and the like);

2) newly creates an object of a virtual function portion; and

3) provides links from LNKs of the objects indicating the real devices to a corresponding portion of the object of the virtual function portion.

Thus, it is also possible to realize the case where virtual functions are grouped by entity equipment, and the real devices are further grouped as equipment groups.

### <Concept of Session>

Association between network devices includes a logical relationship referred to a session, in addition to a physical connection relationship via a LAN cable or the like and a virtual connection relationship in the case where devices are grouped. A session is a unit of a series of processes for making access between cluster devices, and communication by various protocols are performed in each session. In this embodiment, it is possible to express access between devices by such a session in both of a real device network and a virtual device network. In Patent Documents 1 and 2 for prior-art techniques, the concept of this session is not described in a network diagram.

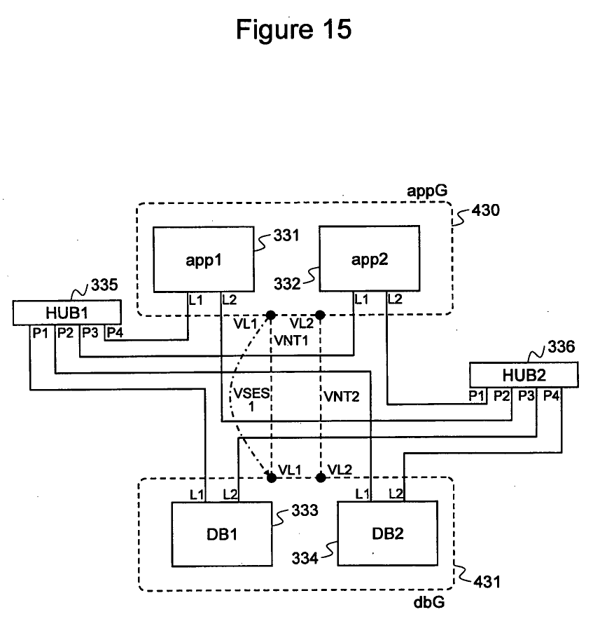

FIG. 15 is a diagram showing an example of expression of a session. In FIG. 15, a session (VSES1) is expressed by a dashed-dotted line arrow on a virtual device network. As shown in FIG. 15, on a virtual device network, a virtual pin of a certain virtual symbol is a start point of a session, and a virtual pin of another virtual symbol is an end point of the session. On a real device network, the pin of a certain device symbol is a start point of a session, and the pin of another device symbol is an end point of the session.

Attribute information (properties) such as a protocol is given to a session, and the attribute information is held in the network configuration data storage section 15 similarly to the attribute information object of a virtual symbol object.

The attribute information about a session can be expressed on a drawing by an icon with the use of an already-known GUI technique, though it is not shown in FIG. 15. In this case, a small icon indicating attribute information about a session is arranged on a dashed-dotted line arrow indicating the session. When editing or reference is actually performed, another window is displayed by clicking the icon so that detailed information about the session can be confirmed.

Protocols for a session include, for example, TCP, UDP and ICMP. In TCP, the start point is src of an Syn packet, and the end point is dst of the Syn packet. In UDP and ICMP, the start point is src of an IP packet, and the end point is dst of the IP packet. Whether the opposite-direction session is possible or not can be specified.

When the start point of a session can be fixed at a particular server, the server is specified as the start point of the session even if the session is through the Internet. As such a session, there is a ping (ICMP ECHO) session from a monitoring terminal to a service server which is made in the case of perform monitoring through the Internet. It is only necessary for a session to hold a start point, an end point, a net to which each equipment is connected (a physical connection relationship), and route information for expression on a drawing.

As described above, it is possible to express connection called as a session on a network diagram, similarly to a net which expresses a physical connection relationship and a virtual net which expresses a virtual connection relationship. For a session expressed on a network drawing, it is possible to set properties, such as a protocol, a port number, and an ICMP command in the case of ICMP. Furthermore, the structure is such that the start and end points of a session can be linked to pins of device symbols in the network diagram.

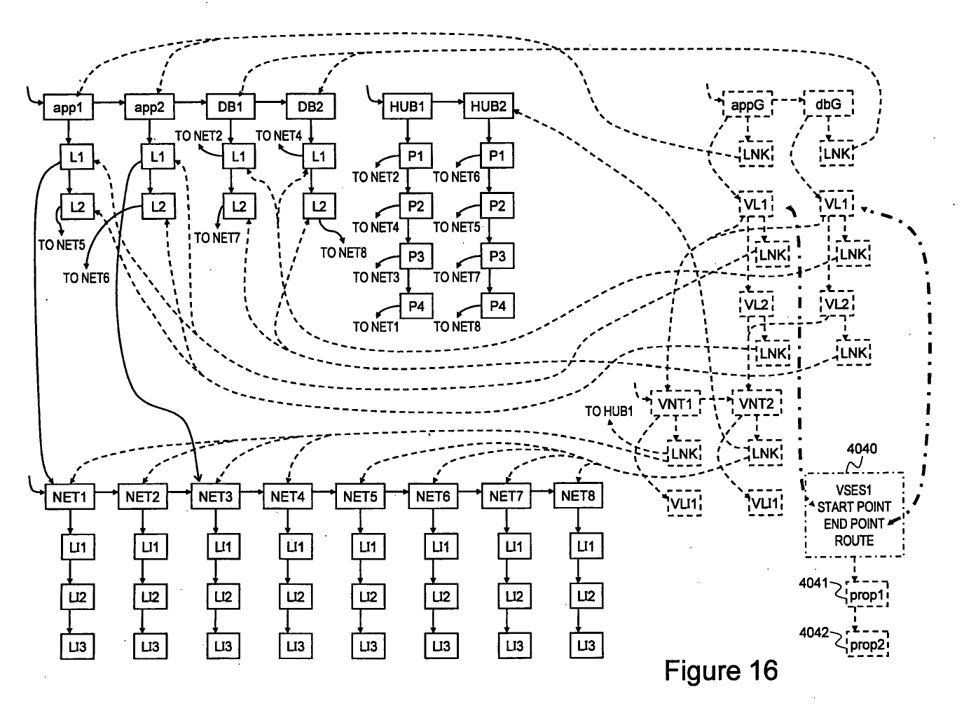

FIG. 16 is a diagram showing an example of the internal data structure of a network diagram in which a session is expressed. The example of the internal data structure in FIG. 16 is an example of the internal data structure of the network drawing expressed in FIG. 15. The internal data structure in FIG. 16 is the internal data structure of the basic real device and virtual device network drawing shown in FIG. 9 added with a session structure. In FIG. 16, reference numeral 404 denotes a session object, and reference numerals 4041 and 4042 denote attribute information objects. The link structure related to the session is indicated by dashed-dotted lines.

As shown in FIG. 16, a link is provided from a virtual pin object (each VL1) of each virtual symbol to be a start/end point of the session to the start/end point of the session object (VSES1). Though this is an example of a session link in a logical virtual device network, a session link in a physical real device network is similar. From such a session object link structure, an device/interface port to be a start point of a session and an device/interface port to be an end point can be easily known. Furthermore, a session object can have links to multiple attribute information objects (prop1 and prop2). An attribute information object can hold logical information such as a communication protocol and a port number.

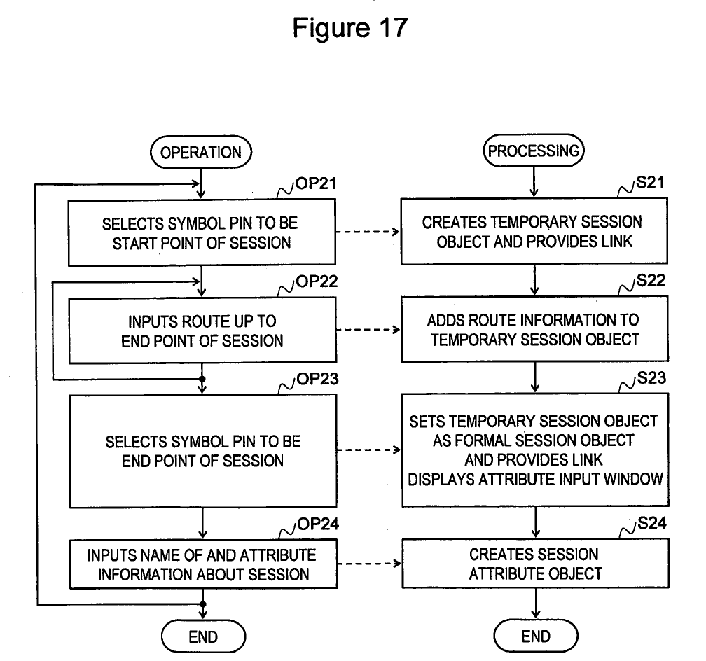

FIG. 17 is a diagram illustrating session information editing processing. Though description will be made on editing of session information in a virtual device network with reference to FIG. 17, editing of session information in a real device network is similar. In this embodiment, a session object in a real device network is called a real session object, and a session object in a virtual device network is called a virtual session object.

When an operation of selecting a virtual pin to be a start point of a session is performed on the network diagram editing screen (OP21), the session information editing section 13 creates a temporary session object. The association processing section 14 provides a link between the virtual pin object to be a start point and the start point of the temporary session object (S21). The temporary session object does not become a formal session object until the end point of the session is determined.

Next, in response to an operation of drawing a line segment while specifying the route toward the end of the session (OP22), the session information editing section 13 adds route information to the temporary session object (S22). The operation OP22 and the processing step S22 are repeated the number of times corresponding to the number of routes required. The route information about the session can be changed later.

When a virtual pin to be the end point of the session is selected on the network diagram (OP23), the session information editing section 13 registers the temporary session object as a formal session object. The association processing section 14 provides a link between the virtual pin object to be the end point and the end point of the session object. The session information editing section 13 displays a window for setting attribute information about the session on the screen and prompts input of the attribute information (S23). The session attribute information can be set after main design is completed. In that case, the session attribute information is inputted by an operation, such as an operation of selecting an arrow graphic indicating the session on the network diagram to open the attribute setting window.

When information defining the attribute information, such as the protocol and the port number of the session, is inputted in the window for setting the session attribute information (OP24), the session information editing section 13 creates a session attribute information object and stores the defined attribute information (S24). The operations OP21 to OP24 and the processing steps S21 to S24 are repeated the number of times corresponding to the number of sessions required. Information about the created session object and attribute information object is stored into the network configuration data storage section 15 after it is confirmed to a designer whether the data is to be stored or not.

<Mapping of Session of Virtual Device Network onto Real Device Network>

In FIG. 16, a structure enabling a link from a virtual pin object of a virtual device to a virtual session object is shown. However, in order to perform automatic generation of setting information about each device, such as definition of a routing table of a network router, and verification on whether or not an device has a realizable interface port, it is necessary to develop a virtual session connecting the virtual interface ports of virtual devices to a real session connecting the interface ports of real devices.

In designing a large-scale system, to express all necessary real sessions for physical connections in a real device network is troublesome and easily causes mistakes. Furthermore, the drawing is filled with sessions and becomes messy. Therefore, it is though that, if there is a method enabling expression of sessions on logical connections and development of them to physical connections, it will be very useful.

Development of a session from a virtual device network to a real device network can be performed with the use of information about association between virtual pins and physical pins. By reaching, from a virtual session object, the virtual pin objects of virtual symbols to be the start/end points of the session and further following the links between the virtual pin object and a physical pin object, devices to be the start/end points of the session in the real device network, and their interface ports can be known.

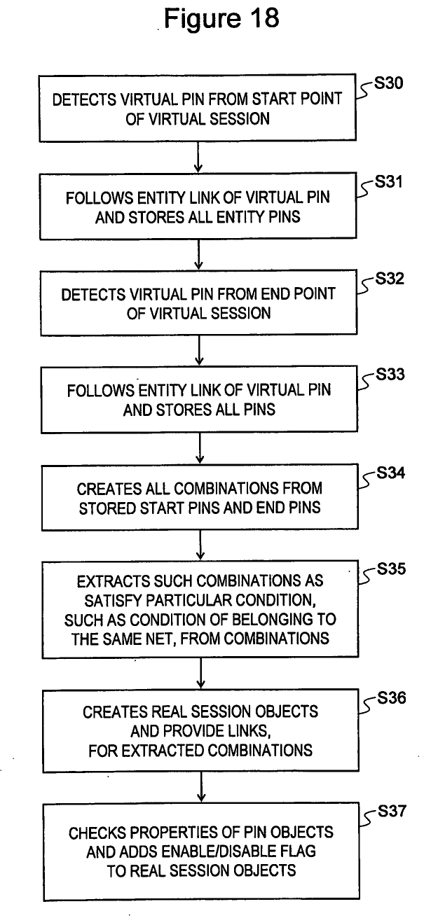

Processing for developing a session from a virtual device network to a real device network will be described below with the use of FIGS. 18 to 22. Here, description will be made on a case where a session in a virtual device network, the start point of which is the virtual pin VL1 of the virtual symbol appG drawn in the network diagram shown in FIG. 15 and the end point of which is the virtual pin VL1 of the virtual symbol dbG, is developed into a real device network as an example. The internal data structure of the network diagram before development is as shown in FIG. 16. In the description below, it is assumed that a session in the virtual device network is called a virtual session and a session in the real device network is called a real session.

FIG. 18 is a flowchart of session development processing. The processing for developing a session from a virtual device network to a real device network which is performed by the session information editing section 13 will be described with the use of FIG. 18.

From link information about the start point of a virtual session to be developed, a virtual pin to be the start point of the virtual session is detected (S30). For example, as shown in FIG. 16, the start point of a virtual session object indicating the virtual session VSES1 is linked to the virtual pin object of the virtual pin VL1 of the virtual symbol appG (hereinafter denoted by appG.VL1). Therefore, appG.VL1 is detected as a virtual pin to be the start point of the virtual session.

By following the link from the detected virtual pin to be the start point of the virtual session, all the pins to be the entities (the pins of real devices) are detected, and they are stored as a set of start points (S31). However, if the link of the virtual pin is to another virtual pin, the link is further followed to detect only pins to be entities, and they are stored as a set of start points. For example, as shown in FIG. 16, the virtual pin object of the virtual pin appG.VL1 is linked to the pin objects of the pin L1 of the device symbol app1 (hereinafter denoted by app1.L1) and the pin L1 of the device symbol app2 (hereinafter denoted by app2.L1). Therefore, app1.L1 and app2.L1 are detected as the pins to be the entities of the virtual pin appG.VL1, and they are stored as a set of start points.

Next, from link information about the end point of the virtual session to be developed, a virtual pin to be the end point of the virtual session is detected (S32). For example, as shown in FIG. 16, the end point of the virtual session object of the virtual session VSES1 is linked to the virtual pin object of the virtual pin VL1 of the virtual symbol dbG (hereinafter denoted by dbG.VL1). Therefore, dbG.VL1 is detected as a virtual pin to be the end point of the virtual session.

By following the link from the detected virtual pin to be the end point of the virtual session, all the pins to be the entities (the pins of real devices) are detected, and the pins, including the virtual pins, are stored as a set of end points (S33). However, if the link of the virtual pin is to another virtual pin, the link is further followed to detect only pins to be entities, and the pins, including the virtual pins, are stored as a set of end points. For example, as shown in FIG. 16, the virtual pin object of the virtual pin dbG.VL1 is linked to pin objects of the pin L1 of the device symbol DB1 (hereinafter denoted by DB1.L1) and the pin L1 of the device symbol DB2 (hereinafter denoted by DB2.L1). Therefore, DB1.L1 and DB2.L1 are detected as the pins to be the entities of the virtual pin dbG.VL1, and the pins, including the virtual pin dbG. VL1, are stored as a set of end points.

All the combinations of start and end pins (including virtual pins) are determined on the basis of the stored set of start points and set of end points. For example, if all the combinations of a pin to be a start point and a pin to be an end point are determined on the basis of the set of start points {app1.L1, app2.L1} and the set of end points {dbG.VL1, DB1.L1, DB2.L1} described above, the following six combinations of start and end points are determined:

app1.L1-dbG.VL1;

app1.L1-DB1.L1;

app1.L1-DB2.L1;

app2.L1-dbG.VL1;

app2.L1-DB1.L1; and

app2.L1-DB2.L1.

From the determined combinations of start and end points, such combinations as satisfy any of the following conditions are extracted (S35).

(Condition 1): a combination of pins belonging to the same net;

(Condition 2): a combination among hubs belonging to the same net and a pin connected via the hubs; and

(Condition 3): such combination of pins that the end point is a virtual pin.

It is assumed that connection between hubs is possible when a pin having a hub and another pin having a hub belong to the same net and the connection is through the net. In the case where the end point is a virtual pin, search is performed from a real net via a virtual net.

For example, when combinations satisfying the conditions 1 to 3 are extracted from the six combinations described above, four combinations of app1.L1-DB1.L1, app1.L1-DB2.L1, app2.L1-DB1.L1 and app2.L1-DB2.L1 are extracted on the basis of the condition 1, and two combinations of app1.L1-dbG.VL1 and app2.L1-dbG.VL1 are extracted on the basis of the condition 3. No combination is extracted on the basis of the condition 2. In this example, all the six combinations are extracted after all.

For the extracted combinations, real session objects are created, and links are provided between the real session objects and the pins (including virtual pins) to be the start/end points of the real sessions (S36). Here, a session the end point of which is a virtual pin is also treated as a real session.

For example, for each of the six combinations described above, a real session object for each real session is created on the assumption of:

session between app1.L1 and dbG.VL1→real session SES1;

session between app1.L1 and DB1.L1→real session SES2;

session between app1.L1 and DB2.L1→real session SES3;

session between app2.L1 and dbG.VL1→real session SES4;

session between app2.L1 and DB1.L1→real session SES5; and

session between app2.L1 and DB2.L1→real session SES6.

For each real session, a link is provided between the start point of the created real session object and a pin to be the start point of the real session. Furthermore, links are provided between the end points of the created real session objects and pins (including virtual pins) to be the end points of the real sessions.

The properties of each of the pins (including virtual pins) are checked, and an enable/disable flag is added to (or changed for) the real session (S37). The processing of step S37 is executed as appropriate when the properties for enabling a link are prepared or changed. For example, in the case of setting a virtual address for a virtual pin, the above sessions SES1 and SES4 are enabled, while, in the case of redundancy of DNS or the like which does not use a virtual address, the above SES1 and SES4 sessions are disabled. In the case of enabling only such accesses that the end point is a virtual address, the above sessions SES2, SES3, SES5 and SES6, which are accesses between entity pins, are disabled.

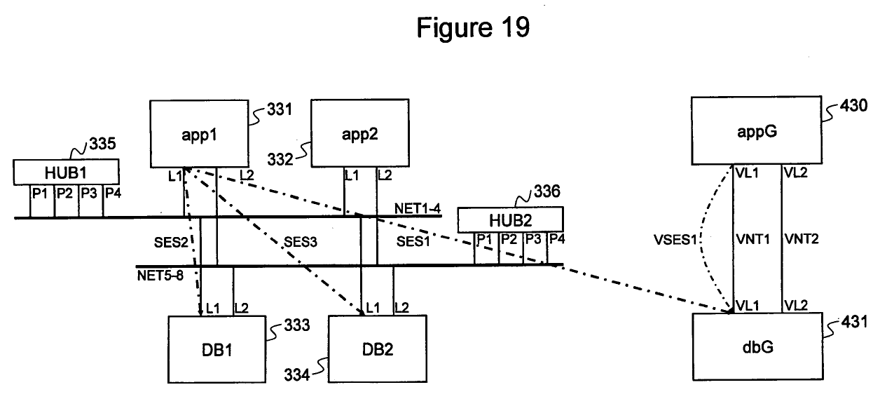

FIG. 19 is a diagram showing an example in which a session has been developed, from a virtual device network to a real device network. The left side of FIG. 19 shows a real device network diagram, and the right side of FIG. 19 shows a virtual device network diagram. In the network diagram on the left side of FIG. 19, connection relationships (NET1-4 and NET 5-8) are shown as wiring harnesses (indicated by heavy lines in the figure) for simplification.

As a result of the development processing described with reference to FIG. 18, the virtual session VSES1 is developed to a real session as shown in FIG. 19. In FIG. 19, only real sessions the start point of which is app1.L1 (the above SES1, SES2 and SES3) are shown in the network diagram so that the diagram can be easy to see. Real sessions the start point of which is app2.L1 (the above SES4, SES5 and SES6) are not shown.

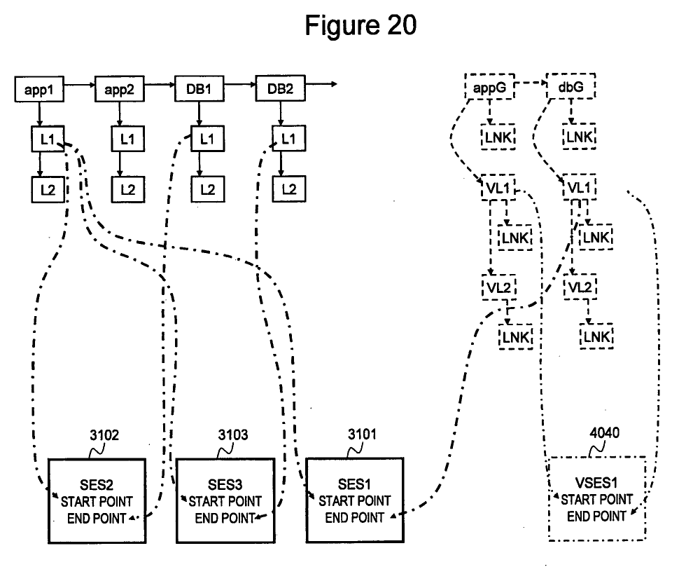

FIG. 20 is a diagram showing an example of an internal data structure when a session is developed from a virtual device network to a real device network. The internal data structure in FIG. 20 is such an internal data structure that attention is especially paid to a developed session portion.

As a result of the development processing described with reference to FIG. 18, real session objects 3101, 3102 and 3103 are created for the real sessions SES1, SES2 and SES3, respectively. For each of them, link information about links to a pin object of a pin to be a start point and a pin object (including a virtual pin object) of a pin (including a virtual pin) to be an end point is set. In FIG. 20, real session objects are shown only for the real sessions SES1, SES2 and SES3 the start point of which is app1.L1. Actually, however, real session objects similarly exist for the real sessions SES4, SES5 and SES6 the start point of which is app2.L1.

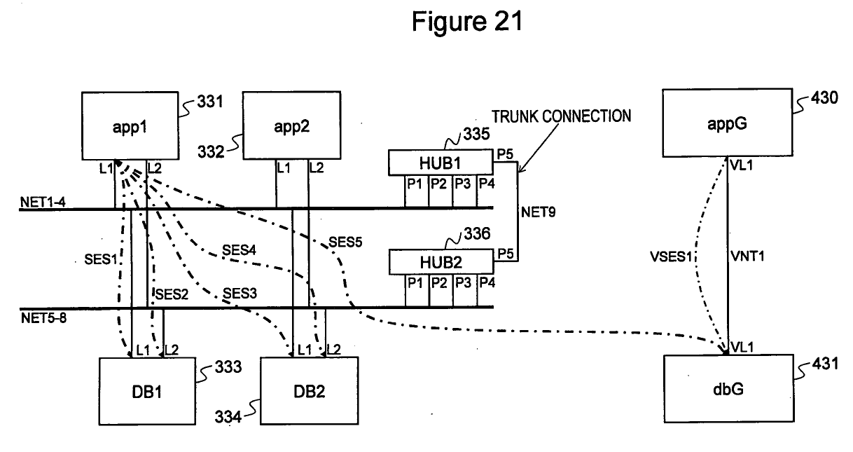

FIG. 21 is a diagram illustrating an example of development of a session in the case where hubs are trunk-connected. The left side of FIG. 21 shows a real device network diagram, and the right side of FIG. 21 shows a virtual device network diagram. In the description of FIG. 18, there was not an example of the case where the condition 2 is satisfied at step S35. Here, description will be made on the case where the condition 2 is satisfied.

In the network diagram on the left side of FIG. 21, connection relationships (NET1-4 and NET 5-8) are shown as wiring harnesses (indicated by heavy lines in the figure) for simplification. In FIG. 21, only real sessions the start point of which is app1.L1 are shown in the network diagram, and real sessions the start point of which is app2.L1 are not shown for simplification of the diagram.

In the example in FIG. 21, HUB1 and HUB2 are trunk-connected via a net NET9. By HUB1 and HUB2 being trunk-connected, for example, connection between app1.L1 and DB1.L2 becomes possible. In the virtual device network diagram on the right side of FIG. 21, only one VL1 is set as a virtual pin for each of a virtual symbol appG and a virtual symbol dbG, and therefore, only one virtual net VNT1 is set.

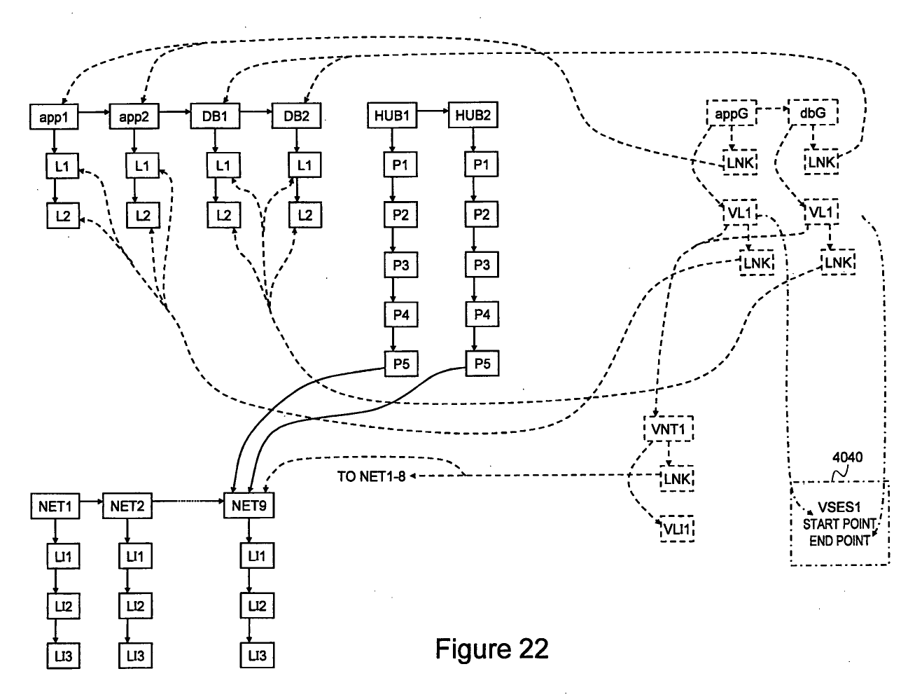

FIG. 22 shows an example of the internal data structure of a network diagram in the case where hubs are trunk-connected. The internal data structure in FIG. 22 shows such an internal data structure that attention is especially paid to a portion where HUB1 and HUB2 are trunk-connected and only VNT1 is a virtual net, and the structures of other portions are not shown. The structures of the omitted portions are similar to the structures shown in FIG. 16.

Description will be made below especially on the case of the combination of app1.L1 and DB1.L2 extracted on the basis of the condition 2 of step S35 in FIG. 18 in development of the virtual session VSES1 to a real session, according to the network diagram example shown in FIG. 21.

By HUB1 and HUB2 being trunk-connected, the link between app1.L1 and DB1.L2 can be followed as shown below:

app1.L1-NET1-HUB1.P4-HUB1.P5-NET9-HUB2.P5-HUB2.P3-NET7-DB1.L2

That is, since the combination of app1.L1 and DB1.L2 satisfies the condition 2 of step S35 in FIG. 18, it is stored as an effective combination.

Thus, it is known that there exist five real sessions the start point of which is app1.L1, including the combinations satisfying the conditions 1 or 3 of step S35 in FIG. 18, as shown in FIG. 21. Similarly, as for real sessions the starting points of which are app1.L2, app2.L1 and app2.L2, there are five each. Therefore, the virtual session VSES1 on the right side of FIG. 21 is developed to twenty real sessions.

### <Overlap Display of Real Device Network Diagram, Virtual Device Network Diagram and Session>

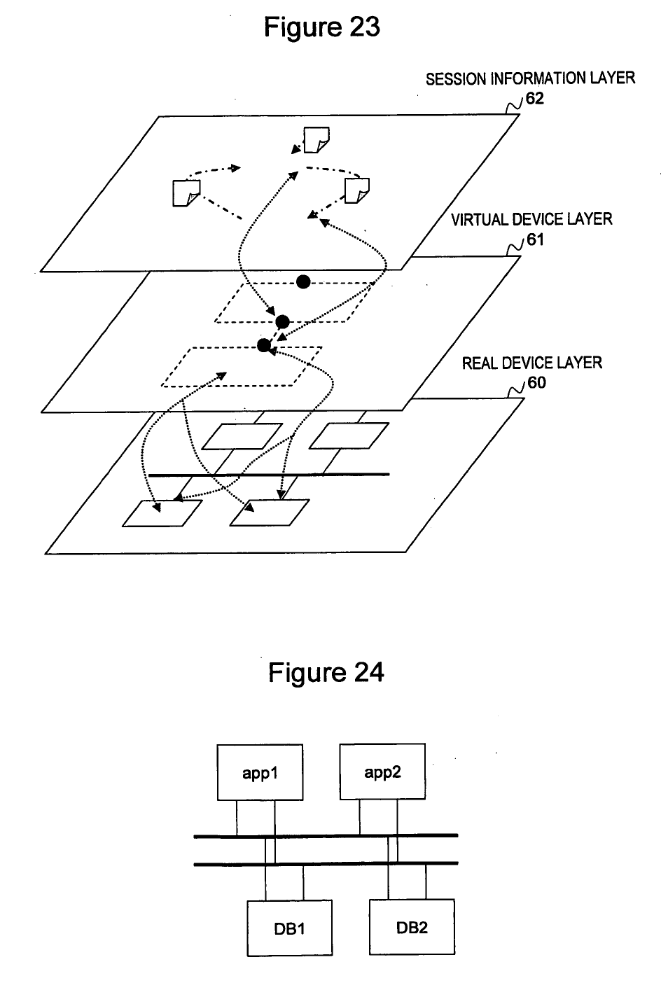

FIG. 23 is a diagram showing the concept of expression of a diagram with layers. The concept of layers can be introduced into a network diagram as shown in FIG. 23 as a real device layer 60, a virtual device layer 61 and a session information layer 62.

A real device network is shown on the real device layer 60; a virtual device network is shown on the virtual device layer 61; and a real or virtual session is shown on the session information layer 62. The entire network diagram is constituted by these three layers.

In FIG. 23, dotted-line arrows among the layers mean links among the layers. These dotted-line arrows are not directly expressed on an actual network diagram. However, when the multiple layers are displayed being overlapped with one another on a drawing, the layers are displayed so that portions linked by an arrow correspond to each other.

In the example in FIG. 23, the layer structure is a three-layer structure. However, an actual layer structure is not limited to the three-layer structure. For example, the session information layer 62 can be separated into a layer expressing a real session and a layer expressing a virtual session. An example will be described below in which a real session layer and a virtual session layer is separated. Furthermore, a layer expressing a session can be separated according to attributes of a session, into layers such as a layer expressing a communication service session for services, a layer expressing a communication maintenance session for maintenance. The layer expressing the service session can be further separated according to services provided by the network system.

Some existing graphic creation tools have the concept of layers. However, the concept of layers of the existing graphic creation tools is intended merely to overlap drawings with one another. In comparison, this embodiment provides a system which capable not only of managing a drawing for each layer but also of integrating and grasping the systems, including a real device network and a virtual device network, by providing links connecting objects among layers. Thereby, the system is not a system merely for creating a network drawing but a system capable of managing information which can be applied to verification of connection between devices, checking of inconsistency between a virtual device network and a real device network, automatic generation of setting information about each device, and the like.

If, in the internal data structure in FIG. 16, a layer management object has pointers to the top of links connecting objects on different layers, a structure capable of internally holding the expression of links on a drawing as shown in FIG. 23 can obtained (see FIG. 29 to be explained later). By editing a network drawing and performing display/non-display control of layers on such a structure, it is possible to refer to a desired network diagram.

FIGS. 24 to 28 are diagrams showing examples of expression of a drawing with layers. By switching display/non-display of each layer, various drawing expressions are possible, such as displaying only a real device network, and displaying all network information as one drawing being overlapped.

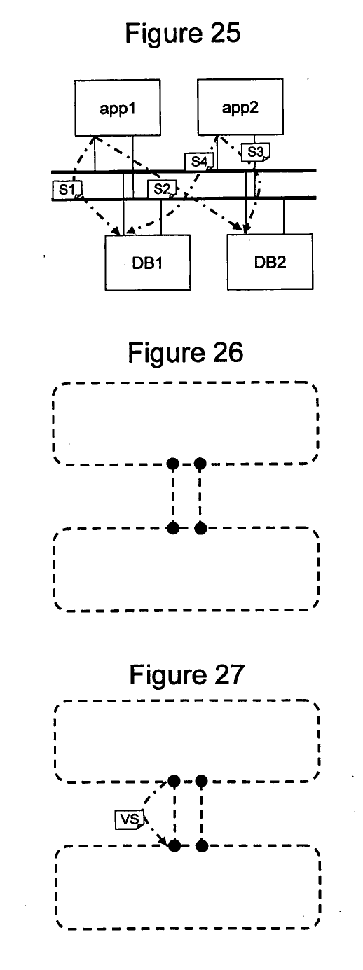

FIG. 24 shows an example in which only the real device network layer is shown. When a layer expressing a real session is added and displayed here, the real session is displayed so that it is superposed on the real device network drawing. FIG. 25 shows an example in which the real device network layer and the layer expressing a real session are displayed being overlapped with each other.

FIG. 26 shows an example in which only the virtual device network layer is shown. When a layer expressing a virtual session is added and displayed here, the virtual session is displayed so that it is superposed on the virtual device network drawing. FIG. 27 shows an example in which the virtual device network layer and the layer expressing a virtual session are displayed being overlapped with each other. In displaying the virtual device network layer, the purposes or names and the number of devices of real devices included in each virtual device may be added to each virtual device and displayed, for example, in the form of “device name×n”.

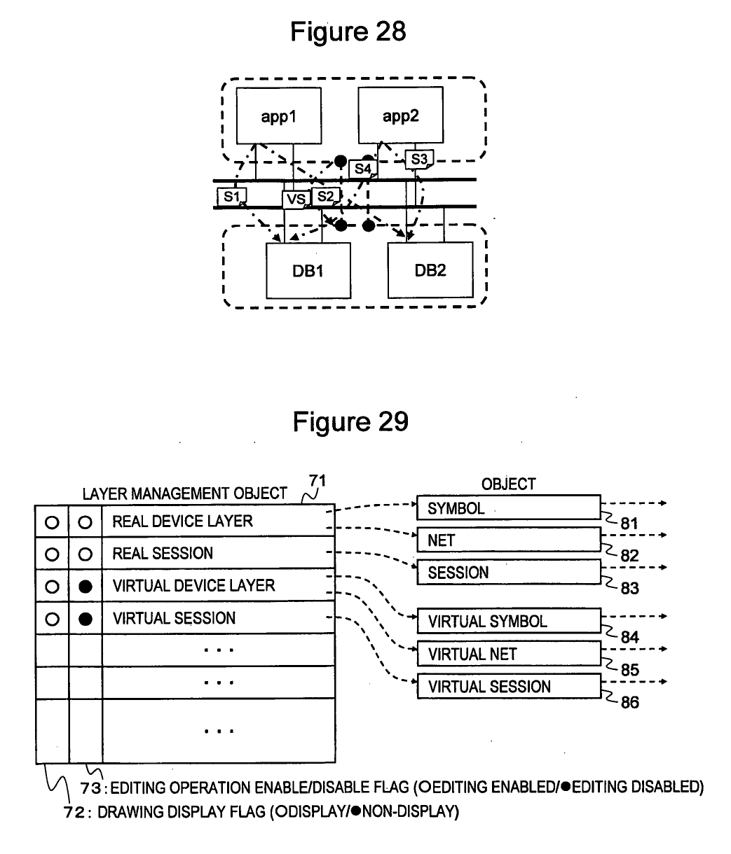

FIG. 28 shows an example in which all the layers are displayed being overlapped with one another. When all the layers are displayed at the same time like this, there may be a case where the network diagram is complicated and the work such as design/editing of the network diagram are difficult to do. In such a case, a designer can simplify the design/editing work by selecting and displaying only a layer required for the work.

FIG. 29 is a diagram showing an example of a layer management structure. A layer management object 71 which internally manages the states of layers has, for each layer, a drawing display flag 72 which controls display/non-display of the layer and an editing operation enable/disable flag 73 which controls whether to enable or disable a drawing editing operation on the layer. Switching of these flags is performed in response to an operation instruction from the designer. Though setting is made so that all the layers are displayed in the example in FIG. 29, it is only on the real device layer and the real session that the editing operation can be performed on. By performing editing work with the editing operation enable/disable flag 73 of a particular layer set to disable editing, it is possible to prevent information about a created layer from being rewritten by mistake.

As shown in FIG. 29, links from the layer management object 71 to top objects 81 to 86 of the objects constituting the network diagram are provided. By following the link of an object targeted by display or editing among the links, it is possible to perform control for each layer.

It is possible not only to display the entire network diagram for each layer or by overlap but also to provide means for partly displaying a specified range in the network diagram. For example, it is possible to provide means for, in displaying the virtual device network layer shown in FIG. 26, developing only specified virtual devices to real devices and displaying by overlap virtual devices and real devices only within a partial range.

Processing for display on a screen or processing for output to a printer or the like on the basis of the layer management information described above is performed by the network configuration data output processing section 16. In addition, the network configuration data output processing section 16 is provided with a function of outputting a list of real devices to be used for checking a designed network system, a list of virtual devices, a list of real sessions, a list of virtual sessions, a list of real interface ports (pins), a list of virtual interface ports, a list of attribute information about them, link information indicating relationships among them, and the like, on the basis of data stored in the network configuration data storage section 15, in response to selection from an output menu by a designer.

The above processing performed by the network design processing device can be realized by a computer and a software program, and the program can be recorded in a computer-readable recording medium or provided through a network.

The present invention is practiced on a computer system having a graphical input/output interface. The present invention is a technique useful especially for enhancement of efficiency/quality of design of a large-scale network infrastructure.

This application is based upon and claims priority of PCT international application No. PCT/JP2006/305358 filed Mar. 17, 2006, the contents being incorporated herein by reference.

What is claimed is:

1. A network design processing device to which a network diagram is inputted with the use of a computer screen and which supports design of a network system, the device comprising:
a network diagram creation processing section which has processing means for creating or editing a real device network diagram constituted by real devices which are actual physical equipment, from input with the use of the computer screen, and processing means for creating or editing a virtual device network diagram constituted by virtual devices by expressing one or multiple real devices having the same purpose or function as a virtual device and connecting virtual interface ports defined for virtual devices;
a network configuration data storage section which stores configuration data of the real device network diagram created or edited by the network diagram creation processing section, configuration data of the virtual device network diagram, and information about the relationship between the configuration data; and
a network configuration data output processing section which switches among output of the real device network diagram, output of the virtual device network diagram and output of a network diagram in which the network diagrams are overlapped with each other, on the basis of the data stored in the network configuration data storage section, in response to specification from the outside, and performs the switched output.

2. The network design processing device according to claim 1, wherein
the network diagram creation processing section has processing means for setting attribute information which logically creates a meaning of the virtual device on the basis of input with the use of the computer screen, and storing the attribute information into the network configuration data storage section in association with the configuration data of the virtual device; and
the network configuration data output processing section has processing means for displaying the attribute information in the virtual device network diagram outputted.

3. The network design processing device according to claim 1, wherein
the network diagram creation processing section has processing means for setting a session indicating a logical connection relationship by communication between real devices in the real device network diagram and a session indicating a logical connection relationship by communication between virtual devices in the virtual device network diagram, on the basis of input with the use of the computer screen, and storing, for each session, session attribute information including information about start/end points of the session into the network configuration data storage section; and
the network configuration data output processing section has processing means for displaying information about the session being overlapped with the real device network diagram, the virtual device network diagram to be outputted, or both of the diagrams.

4. The network design processing device according to claim 3, wherein
the network diagram creation processing section has processing means for determining, on the basis of the information about the session set in the virtual device network diagram, the positions of corresponding start and end points in the real device network diagram from the information about the start and end points of the session, developing the session in the virtual device network diagram to a corresponding session in the real device network diagram, and storing information about the developed session into the network configuration data storage section.

5. The network design processing device according to claim 1, wherein
the network diagram creation processing section has processing means for, on the basis of input with the use of the computer screen, grouping the multiple virtual devices and indicating the groups as new virtual devices, and storing configuration data of the new virtual devices into the network configuration data storage section.

6. A network design processing method to be executed by a network design processing device to which a network diagram is inputted with the use of a computer screen and which supports design of a network system, the method comprising the steps of:
creating or editing a real device network diagram constituted by real devices which are actual physical equipment by arranging, on the basis of input with the use of the computer screen, device symbols in a network diagram on the screen and connecting input/output pins of the device symbols, and storing configuration data of the real device network diagram into a network configuration data storage section;
creating or editing a virtual device network diagram constituted by virtual devices by inputting information selecting one or multiple real devices having the same purpose or function in the real device network diagram, assigning a virtual symbol indicating a virtual device to a group of the selected real devices, inputting information defining a virtual pin to be a virtual interface port for each virtual symbol, and inputting information connecting the virtual pins, and storing configuration data of the virtual device network diagram into the network configuration data storage section;
inputting information indicating correspondence relationships between the pins of the device symbols and the pins of the virtual symbols, and storing the information indicating the correspondence relationships into the network configuration data storage section; and
switching among output of the real device network diagram, output of the virtual device network diagram and output of a network diagram in which the network diagrams are overlapped with each other, on the basis of the data stored in the network configuration data storage section, in response to specification from the outside, and performs the switched output.

7. A network design processing method to be executed by a network design processing device to which a network diagram is inputted with the use of a computer screen and which supports design of a network system, the method comprising the steps of
creating or editing a virtual device network diagram constituted by virtual devices by arranging, on the basis of input with the use of the computer screen, virtual symbols indicating virtual devices which are virtual network equipment on the screen, inputting information defining a virtual pin to be a virtual interface port for each virtual symbol, and inputting information for connecting the virtual pins, and storing configuration data of the virtual device network diagram into the network configuration data storage section;
creating or editing a real device network diagram constituted by real devices by arranging, on the basis of input with the use of the computer screen, one or multiple device symbols indicating real devices, which are actual physical equipment having the same purpose or function, for each of the virtual symbols in association with the virtual symbol, inputting information about correspondence between input/output pins of the device symbols and the virtual pins, and connecting the input/output pins of the device symbols, and storing configuration data of the real device network diagram and information about the relationship between the configuration data and the configuration data of the virtual device network diagram into the network configuration data storage section; and
switching among output of the real device network diagram, output of the virtual device network diagram and output of a network diagram in which the network diagrams are overlapped with each other, on the basis of the data stored in the network configuration data storage section, in response to specification from the outside, and performs the switched output.

8. A computer-readable recording medium in which a network design processing program is recorded, the program being for causing a computer to execute processing to be performed by a network design processing device to which a network diagram is inputted with the use of a computer screen and which supports design of a network system, and the program causing the computer to function as:
a network diagram creation processing section which has processing means for creating or editing a real device network diagram constituted by real devices which are actual physical equipment, from input with the use of the computer screen, and processing means for creating or editing a virtual device network diagram constituted by virtual devices by expressing one or multiple real devices having the same purpose or function as a virtual device and connecting virtual interface ports defined for virtual devices;
a network configuration data storage section which stores configuration data of the real device network diagram created or edited by the network diagram creation processing section, configuration data of the virtual device network diagram, and information about the relationship between the configuration data; and
a network configuration data output processing section which switches among output of the real device network diagram, output of the virtual device network diagram and output of a network diagram in which the network diagrams are overlapped with each other, on the basis of the data stored in the network configuration data storage section, in response to specification from the outside, and performs the switched output.
